(19) United States
(12) Patent Application Publication
(10) Pub. No.: US 2024/0430655 A1
(43) Pub. Date: Dec. 26, 2024

(54) CONFIGURING A HIGH-RISK ZONE

(71) Applicant: Lenovo (Singapore) Pte. Ltd., New Tech Park (SG)

(72) Inventors: Emmanouil Pateromichelakis, Viersen (DE); Dimitrios Karampatsis, Ruislip (GB)

(21) Appl. No.: 18/699,214

(22) PCT Filed: Nov. 11, 2021
(86) PCT No.: PCT/EP2021/081441

§ 371 Date: Apr. 5, 2024

(30) Foreign Application Priority Data
Oct. 5, 2021 (GR) 20210100681

(51) Int. Cl. H04W 4/90; H04W 4/02; H04W 4/40; H04W 4/50

(52) U.S. Cl. CPC H04W 4/90; H04W 4/023; H04W 4/40; H04W 4/50

(57) ABSTRACT

Apparatuses, methods, and systems are disclosed for zone configuration and provisioning for Vulnerable Road User VRU protection. One apparatus includes a receiver that receives a request to create a high-risk zone, the request including an application requirement that indicates at least a target area, and a processor that determines a VRU high-risk zone configuration in response to receiving the application requirement. The apparatus includes a transmitter that transmits a first set of zone configuration parameters to at least one user equipment UE based on the determined VRU high-risk zone configuration and transmits a second set of zone configuration parameters to at least one network function in a mobile communication network.

### FIELD

The subject matter disclosed herein relates generally to wireless communications and more particularly relates to procedures to configure and provision a Vulnerable Road User (“VRU”) high risk area.

### BACKGROUND

Certain wireless networks support cellular-assisted communication among vehicles in V2X communications for both safety and traffic efficiency related applications. Vulnerable Road User Protection (“VRUP”) provides warning to vehicles of the presence of vulnerable road users, e.g., pedestrian or cyclist, in case of a dangerous situation.

### BRIEF SUMMARY

Disclosed are procedures for zone configuration and provisioning for VRU protection. Said procedures may be implemented by apparatus, systems, methods, or computer program products.

One method of a control unit for zone configuration and provisioning for VRU protection includes receiving a request to create a high-risk zone and determining a Vulnerable Road User (“VRU”) high-risk zone configuration in response to receiving the request, the request including an application requirement that indicates at least a target area. The method includes transmitting a first set of zone configuration parameters to at least one User Equipment (“UE”) based on the determined VRU high-risk zone configuration and transmitting a second set of zone configuration parameters to at least one network function in a mobile communication network.

One method of a UE for zone configuration and provisioning for VRU protection includes detecting an emergency event and transmitting an incident notification to a control unit in response to the emergency event. The method includes receiving a first set of zone configuration parameters based on a VRU high-risk zone configuration and relaying the received zone configuration parameters to one or more nearby Vehicle-to-Everything (“V2X”) UEs.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1A is a block diagram illustrating one embodiment of a wireless communication system for zone configuration and provisioning for VRU protection;

FIG. 1B is a schematic block diagram illustrating one embodiment of a wireless communication system supporting edge computing service;

FIG. 2 is a diagram illustrating one embodiment of a network for configuring and provisioning a VRU high risk zone area;

FIG. 3 is a diagram illustrating one embodiment of a Vehicle-to-Everything (“V2X”) protocol stack for a device-to-device (“D2D”) interface;

FIG. 4 is a block diagram illustrating one embodiment of a Fifth-Generation (“5G”) New Radio (“NR”) protocol stack;

FIGS. 5A-5B depict a procedure for the configuration and provisioning of the VRU high risk zone, according to embodiments of the disclosure;

FIG. 6 depicts a procedure for dynamic zone creation, according to embodiments of the disclosure;

FIG. 7 depicts a procedure for MEC-platform enabled zone configuration and provisioning, according to embodiments of the disclosure;

FIG. 8 is a block diagram illustrating one embodiment of a user equipment apparatus that may be used for zone configuration and provisioning for VRU protection;

FIG. 9 is a block diagram illustrating one embodiment of a network apparatus that may be used for zone configuration and provisioning for VRU protection;

FIG. 10 is a flowchart diagram illustrating one embodiment of a first method for zone configuration and provisioning for VRU protection; and

FIG. 11 is a flowchart diagram illustrating one embodiment of a second method for zone configuration and provisioning for VRU protection.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart diagrams and/or block diagrams.

The call-flow diagrams, flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the call-flow, flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatus for configuring and provisioning Vulnerable Road User (“VRU”) high risk area zones and how to translate the VRU zone requirements to network requirements to ensure meeting the application requirements, while maintaining 5GS and device efficiency. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

Vulnerable Road User Protection (“VRUP”) provides warning to vehicles of the presence of vulnerable road users, e.g., pedestrian or cyclist, in case of dangerous situation. For Day 1 application, the infrastructure can recognize the risk and send notifications to vehicles. For day 2, vehicles and infrastructure can share information about pedestrians or cyclists detected via local sensors, and let receiving vehicles detect the occurrence of risky situations associated to VRU presence. Table 1 defines some use cases for the VRUP.

TABLE 1

| Use case category | Description |
|---|---|
| Category A | Direct VRUs communication. In this case, the VRUs are equipped with a device |
| | (VRU-Tx, VRU-Rx, or VRU-St configuration) embedding at least one ITS-S, as |
| | described in ETSI EN 302 665 and potentially other types of applications. |
| Category B | Direct VRU to vehicle communication. The VRU is equipped with a device (VRU- |
| | Tx, VRU-Rx, or VRU-St configuration) embedding at least one ITS-S; the vehicle |
| | is also equipped with an ITS-S compliant with the relevant VRU standards. |
| Category C | Assistance of a third party (a vehicle) detecting a hidden VRU and signaling it to |
| | other vehicles. The VRU may not be equipped (VRU or VRU-Tx configuration) |
| | while the vehicles have an ITS-S complying with the VRU standards. |
| Category D | Assistance of a third party (a Road Side Equipment or RSE) detecting a hidden |
| | VRU and signaling it to approaching vehicles. The VRU may not be equipped |
| | (VRU or VRU-Tx configuration) while the RSE and vehicles are equipped with |
| | ITS-S complying with VRU standards. |
| Category E | Assistance of a third party (a control center or cloud server) monitoring the |
| | evolution of VRUs. The VRUs may be equipped with an ITS-S (VRU-Tx, VRU- |
| | Rx, or VRU-St configuration) complying with VRU standards, detecting risks of |
| | collisions with monitored vehicles and then acting to avoid collision (sending |
| | alarm or collision avoidance instructions). RSE and vehicles are equipped with |
| | ITS-S complying with VRU standards. Category F Assistance of a third party (an |
| | RSE) monitoring the evolution of VRUs equipped with an ITS-S (VRU-Tx, VRU- |
| | Rx, or VRU-St configuration) complying with VRU standards, detecting risks of |
| | collisions with monitored vehicles and then acting to avoid collision (sending |
| | alarms or collision avoidance instructions). RSE and vehicles need to be equipped |
| | with ITS-S complying with VRU standards. Edge computing is part of this |
| | category. |

Focusing more on the V2P scenario (category B), some example use cases can be related to:
Active roadwork, where vehicles provide CAM/DENM messages to the workers/pedestrians. Also, it is possible the standard VRU messages are continuously broadcasted.
VRU crossing a road, where the VRU user sends VRU standard messages continuously or based on context perception (e.g., CPM), and receives collision warnings via CAM messages if there is some risk
Rider is ejected from his motorbike
Emergency Electronic Brake Light
Motorcycle Approach Indication/Motorcycle Approach Warning

To assist the control of the VRU use cases/service, some messages need to be exchanged in application layer between applications running the service. Some example messages for VRUP include the Personal Safety Message (“PSM”) (defined in SAE J2945/9), the VRU Awareness Message (“VAM”), Collective Perception Message (“CPM”), CAM messages, DENM message, and BSM messages.

VRU standard message, named Vulnerable Road User Awareness Message (“VAM”), is designed as a separate message (e.g., for application layer message exchange). The advantages of a VRU standard message are the following:
a message different from the CAM message.
a more flexible message in length and content.
a message tentatively harmonized with the Personal Safety Message (PSM)

The VAM shall contain all required data depending on the VRU profile and the actual environmental conditions. The data elements in the VAM should be as described in Table 2, below.

TABLE 2
VAM message

| Parameter | | Comments |
|---|---|---|
| VAM header including VRU identifier | M | |
| VRU position | M | |
| Generation time | M | |
| VRU profile | M | |
| VRU type | M | e.g. VRU profile is pedestrian, VRU type is infant, |
| | | animal, adult, child, etc. |
| VRU cluster identifier | O | |
| VRU cluster position | O | |
| VRU cluster dimension | O | geographical size |
| VRU cluster size | O | number of members in the cluster |
| VRU size class | C | mandatory if outside a VRU cluster, |
| | | optional if inside a VRU cluster |
| VRU weight class | C | mandatory if outside a VRU cluster, |
| | | optional if inside a VRU cluster |
| VRU speed | M | |
| VRU direction | M | |
| VRU orientation | M | |
| Predicted trajectory | O | succession of way points |
| Predicted velocity | O | including 3D heading and average speed |
| Heading change indicators | O | turning left or turning right indicators |
| Hard braking indicator | O | |

NOTE:
“M” stands for “mandatory” which means that the data element shall be always included in the VAM message. “O” stands for “optional” which means that the data element can be included in the VAM message. “C” stands for “conditional” which means that the data element shall be included in the VAM message under certain conditions.

Regarding the Collective Perception Message (“CPM”), the sending of CPMs comprises the generation and transmission of CPMs. In the course of CPM generation, the originating ITS-S composes the CPM, which is then delivered to the ITS networking & transport layer for dissemination. The dissemination of CPMs may vary depending on the applied communication system. CPMs are sent by the originating ITS-S to all ITS-Ss within the direct communication range. This range may, inter alia, be influenced in the originating ITS-S by changing the transmit power depending on the relevance area.

CPMs are generated periodically with a rate controlled by the Collective Perception (“CP”) service in the originating ITS-S. The generation frequency is determined by taking into account the dynamic behavior of the detected object status, e.g., change of position, speed or direction, sending of CPMs for the same (perceived) object by another ITS-S, as well as the radio channel load.

Upon receiving a CPM, the CP service makes the content of the CPM available to the ITS applications and/or to facilities within the receiving ITS-S, such as a Local Dynamic Map (LDM). The CPM comprises a management container and a set of CPM parameters including perception data. The perception data includes one or more sets (i.e., up to 128) of sensor information containers, one or more sets (i.e., up to 128) of perceived object containers, and one or more sets (i.e., up to 128) of free space addendum containers, e.g., as defined in ETSI TS 103 324. Optionally, the CPM parameters may include including a station data container, e.g., comprising an originating vehicle container and/or an originating RSU container.

For V2P communications, e.g., VRU, CPM messages could be used as input for triggering an action at application layer of the device (e.g., activating a VRU app). This may also help detecting a VRU at risk. For example, in vehicle, reception of a CPM signaling the presence of a vehicle crossing the VRU predicted trajectory. This may be correlated with information received from local sensors.

Cooperative Awareness Message (CAM) (i.e., defined in ETSI EN 302 637-2) are messages exchanged in the ITS network between ITS-Ss to create and maintain awareness of each other and to support cooperative performance of vehicles using the road network. A CAM contains status and attribute information of the originating ITS-S. The content varies depending on the type of the ITS-S. For vehicle, the status information includes time, position, motion state, activated systems, etc. and the attribute information includes data about the dimensions, vehicle type and role in the road traffic, etc.

The Decentralized Environmental Notification Message (“DENM”) are event based messages to notify on an incident/risk/accident etc. The DENM may be as defined in ETSI EN 302 637-3.

The Basic Safety Message (“BSM”) is defined in SAE J2735 and is used in a variety of applications to exchange safety data regarding vehicle state.

The Fifth Generation Automotive Association (“5GAA”) is an automotive industry association which provides recommendations on the 5G enhancements needed based on V2X application requirements. 5GAA has also provided some use cases for V2P communications, considering ETSI ITS and scenarios from automotive industry. In 5GAA, some scenarios are considered one of which is the definition of high risk zones:

VRU high risk zones: Drivers (or automated vehicles) are delivered warnings when they enter a high risk area where there is a likely presence of many VRUs. The high-risk area can be static (e.g., a school during arrival and leaving times), or dynamic (e.g., a school bus or mobile ice-cream vendor). Dedicated roadside infrastructure could play a vital role in disseminating warning messages to VRUs and vehicles as well. In this scenario, the following use cases have been identified:
Pedestrian in crosswalks—send out alerts to motorists when pedestrian in a mid-block crossing. (Can be infrastructure-based messages to motorists).
Pedestrians in crosswalks at intersections. Provide alerts to motorist when pedestrians are crossing a side street on right or left of vehicle. Also provide alerts when pedestrian in crosswalk and signal is green for vehicle. (Can be infrastructure-based messages to motorist).
School Zone Warning—Send out alerts to motorist when they are entering a school zone area that is active. High concentration of pedestrians around the area at specific times, such as arriving and leaving times.
School bus warning. Similar to 1.3, but a dynamic high risk area (e.g., school bus, ice cream truck).

One issue at the scenario of the VRU high risk zone areas is how to configure the zones (area, time validity, groupings) and how to translate such zones (which are application driven) to network requirements and configurations. Furthermore, another issue is how to dynamically configure the devices to use the VRU applications on-time and how 5GS can provide assistance in this regard.

Described herein are solutions for how the VRU high risk area zones are configured and provisioned to the UEs, and what is the impact/needed enhancements at the 5GS to assist the corresponding UEs to access the VRUP services.

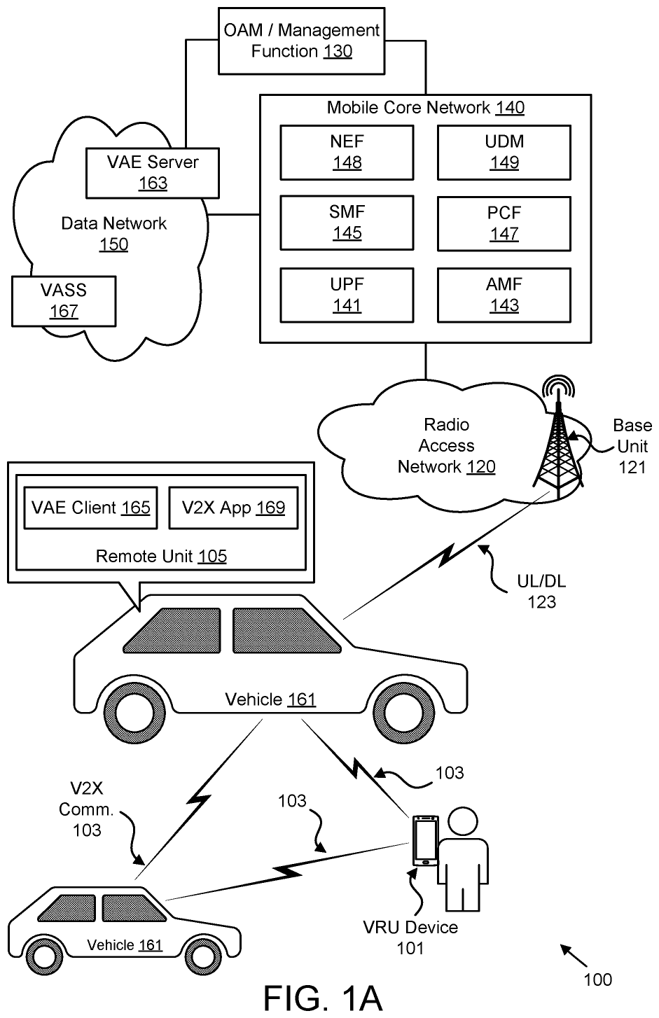

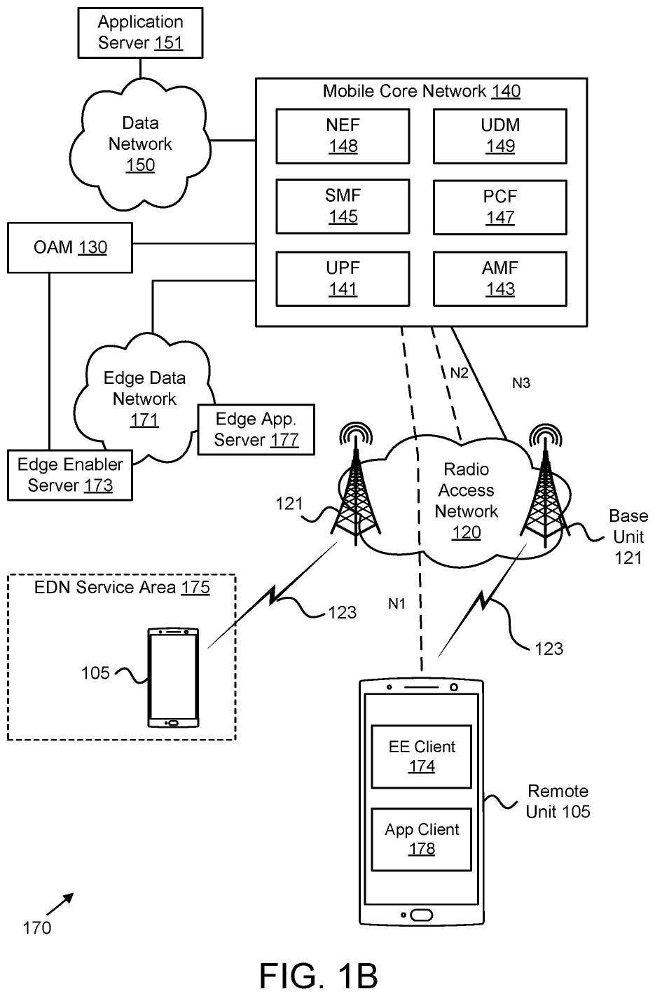

FIGS. 1A-1B depict a wireless communication system 100 for zone configuration and provisioning for VRU protection, according to embodiments of the disclosure. In various embodiments, the wireless communication system 100 includes at least one remote unit 105, a radio access network (“RAN”) 120, and a mobile core network 140. The RAN 120 and the mobile core network 140 form a mobile communication network. The RAN 120 may be composed of a base unit 121 with which the remote unit 105 communicates using wireless communication links 123. Even though a specific number of remote units 105, base units 121, wireless communication links 123, RANs 120, and mobile core networks 140 are depicted in FIGS. 1A-1B, one of skill in the art will recognize that any number of remote units 105, base units 121, wireless communication links 123, RANs 120, and mobile core networks 140 may be included in the wireless communication system 100.

In one implementation, the RAN 120 is compliant with the Fifth-Generation (“5G”) system specified in the Third Generation Partnership Project (“3GPP”) specifications. For example, the RAN 120 may comprise a New Generation Radio Access Network (“NG-RAN”), implementing New Radio (“NR”) Radio Access Technology (“RAT”) and/or Long-Term Evolution (“LTE”) RAT. In another example, the RAN 120 may comprise a non-3GPP RAT (e.g., Wi-Fi® or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any particular wireless communication system architecture or protocol.

In FIG. 1A, the wireless communication system 100 supports a V2X vertical, including vehicles 161, a V2X Application Enabler (“VAE”) Server 163 and VAE client 165, and at least one V2X Application-specific Server (“VASS”) 167 and V2X application client 169. As depicted, the vehicles 161 include a remote unit 105 and may communicate directly with each other (e.g., device-to-device communication) using V2X communication signals 103. Here, V2X transmissions may occur on V2X resources. A remote unit 105 may be provided with different V2X communication resources for different V2X modes. Mode-1 corresponds to a NR network-scheduled V2X communication mode. Mode-2 corresponds to a NR UE-scheduled V2X communication mode. Mode-3 corresponds to an LTE network-scheduled V2X communication mode. Mode-4 corresponds to an LTE UE-scheduled V2X communication mode.

The remote unit 105 includes a VAE client 165 at a V2X middleware layer (i.e., an application-enabling function), which is configured to report to the VAE server 163 whenever a certain condition occurs indicating a need to adapt a network profile mapping.

As depicted, the communication system 100 may also include a VRU device 101, which comprises a non-vehicular embodiment of the remote unit 105. As described in greater detail below, the VRU device 101 may include an instance of the VAE client 165.

The V2X application enabler (“VAE”) layer supports efficient use and deployment of V2X services over 3GPP systems, e.g., by providing support functionalities for V2X use cases. This VAE layer comprises a VAE server 163 which may be either a PLMN-owned or a third party/vertical server, and one or more VAE clients 165 at the vehicle/remote unit 105 side. The VAE server 163 is a middleware platform that provides support functionalities to the enabler clients; and interacts with the application specific servers (e.g., platooning server) as well as with the involved PLMNs, to ensure meeting the per vertical requirements.

There, the server-and client-side V2X application layer support functions are defined:

The VAE server 163 provides the server-side V2X application layer support functions, including communicating with the underlying 3GPP network system for unicast and multicast network resource management, receiving monitoring reports/events from the underlying 3GPP network system (5GS and/or EPS) regarding network situation corresponding to RAN and core network, supporting registration of V2X UEs, tracking the application level geographic location of the V2X UEs, supporting V2X message distribution for the V2X applications, supporting provisioning of 3GPP system configuration information (e.g., V2X USD, PC5 parameters), perform the role of content provider for multicast file transfer using xMB APIs, providing network monitoring reports to the V2X UEs, communicating V2X service requirements to the underlying 3GPP network system (5GS and/or EPS), maintaining the mapping between the V2X user ID and the V2X UE ID, providing V2X service discovery, supporting V2X service continuity, and supporting V2X application resource adaptation.

The VAE client 165 provides the client-side V2X application layer support functions, including registration of VAE clients 165 for receiving V2X messages, receiving V2X messages from the VAE server 163 and the delivery to V2X application specific client(s) according to the V2X service ID, perform the role of the MBMS client for multicast file transfer using xMB APIs, receiving network monitoring reports from the VAE server, supports switching the modes of operations for V2V communications (e.g., between direct and indirect V2V communications), providing application-level locations to the VAE server 163 (e.g., tile, geo-fence), receiving 3GPP system configuration information (e.g., V2X USD, PC5 parameters) from the VAE server 163, supporting dynamic group management, and supporting interactions with the V2X application specific client(s) 169.

In FIG. 1B, the wireless communication system 170 supports an edge computing service deployment including at least one edge data network (“EDN”) 171 supporting an EDN service area 123. The EDN 171 includes at least one Edge Application Server (“EAS”) 177 supporting an instance of an application. When a remote unit 105 is located in the EDN service area 175, Application client (“AC”) 178 is able to access the EAS 177. However, when the remote unit 105 is outside any EDN service area, the AC 178 instead accesses an instance of the application using the Application server 151 located in the data network 150 (i.e., a regional data network). The EDN 171 also includes an edge enabler server (“EES”) 173, a middleware application enabler server, while the remote unit 105 includes a corresponding edge enabler client (“EEC”) 174.

With respect to both FIG. 1A and FIG. 1B, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the base units 121 in the RAN 120 via uplink (“UL”) and downlink (“DL”) communication signals. Furthermore, the UL and DL communication signals may be carried over the wireless communication links 123. Here, the RAN 120 is an intermediate network that provides the remote units 105 with access to the mobile core network 140.

In some embodiments, the remote units 105 communicate with a communication host (e.g., V2X Application-Specific Server 167, edge application server 173 and/or application server 151) via a network connection with the mobile core network 140. For example, an application client (e.g., web browser, media client, telephone/VOIP application, V2X application client 169, edge application client 179) in a remote unit 105 may trigger the remote unit 105 to establish a protocol data unit (“PDU”) session (or other data connection) with the mobile core network 140 via the RAN 120. The mobile core network 140 then relays traffic between the remote unit 105 and the communication host (i.e., application server) using the PDU session. The PDU session represents a logical connection between the remote unit 105 and the User Plane Function (“UPF”) 141

In order to establish the PDU session (or PDN connection), the remote unit 105 must be registered with the mobile core network 140 (also referred to as “attached to the mobile core network” in the context of a Fourth Generation (“4G”) system). Note that the remote unit 105 may establish one or more PDU sessions (or other data connections) with the mobile core network 140. As such, the remote unit 105 may have at least one PDU session for communicating with the packet data network 150. The remote unit 105 may establish additional PDU sessions for communicating with other data networks and/or other communication peers.

In the context of a 5G system (“5GS”), the term “PDU Session” refers to a data connection that provides end-to-end (“E2E”) user plane (“UP”) connectivity between the remote unit 105 and a specific Data Network (“DN”) through the UPF 141. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QOS Identifier (“5Q1”).

In the context of a 4G/LTE system, such as the Evolved Packet System (“EPS”), a Packet Data Network (“PDN”) connection (also referred to as EPS session) provides E2E UP connectivity between the remote unit and a PDN. The PDN connectivity procedure establishes an EPS Bearer, i.e., a tunnel between the remote unit 105 and a Packet Gateway (“PGW”, not shown) in the mobile core network 140. In certain embodiments, there is a one-to-one mapping between an EPS Bearer and a QoS profile, such that all packets belonging to a specific EPS Bearer have the same QoS Class Identifier (“QCI”).

The base units 121 may be distributed over a geographic region. In certain embodiments, a base unit 121 may also be referred to as an access terminal, an access point, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The base units 121 are generally part of an access network (“AN”), such as the RAN 120, that may include one or more controllers communicably coupled to one or more corresponding base units 121. These and other elements of radio access network are not illustrated but are well known generally by those having ordinary skill in the art. The base units 121 connect to the mobile core network 140 via the RAN 120.

The base units 121 may serve a number of remote units 105 within a serving area, for example, a cell or a cell sector, via a wireless communication link 123. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base units 121. Note that during NR operation on unlicensed spectrum (referred to as “NR-U”), the base unit 121 and the remote unit 105 communicate over unlicensed (i.e., shared) radio spectrum.

In one embodiment, the mobile core network 140 is a 5G core (“5GC”) or an Evolved Packet Core (“EPC”), which may be coupled to a packet data network 150, like the Internet and private data networks, among other data networks. A remote unit 105 may have a subscription or other account with the mobile core network 140. Each mobile core network 140 belongs to a single mobile network operator (“MNO”) or public land mobile network (“PLMN”). The present disclosure is not intended to be limited to the implementation of any particular wireless communication system architecture or protocol.

The mobile core network 140 includes several network functions (“NFs”). As depicted, the mobile core network 140 includes at least one user plane function (“UPF”) 141. The mobile core network 140 also includes multiple control plane (“CP”) functions including, but not limited to, an Access and Mobility Management Function (“AMF”) 143 that serves the RAN 120, a Session Management Function (“SMF”) 145, a Policy Control Function (“PCF”) 147, a Network Exposure Function (“NEF”) 148, and a Unified Data Management function (“UDM”) 149. Although specific numbers and types of network functions are depicted in FIG. 1, one of skill in the art will recognize that any number and type of network functions may be included in the mobile core network 140.

The UPF(s) 141 is/are responsible for packet routing and forwarding, packet inspection, QoS handling, and external PDU session for interconnecting Data Network (DN), in the 5G architecture. The AMF 143 is responsible for termination of NAS signaling, NAS ciphering & integrity protection, registration management, connection management, mobility management, access authentication and authorization, security context management. The SMF 145 is responsible for session management (i.e., session establishment, modification, release), remote unit (i.e., UE) IP address allocation & management, DL data notification, and traffic steering configuration of the UPF 141 for proper traffic routing.

The PCF 147 is responsible for unified policy framework, providing policy rules to CP functions, access subscription information for policy decisions in UDR. The UDM is responsible for generation of Authentication and Key Agreement (“AKA”) credentials, user identification handling, access authorization, subscription management. The UDR is a repository of subscriber information and may be used to service a number of network functions. For example, the UDR may store subscription data, policy-related data, subscriber-related data that is permitted to be exposed to third party applications, and the like. In some embodiments, the UDM is co-located with the UDR, depicted as combined entity “UDM/UDR” 149.

In various embodiments, the mobile core network 140 may also include an Authentication Server Function (“AUSF”) for performing 5G authentication procedures, a Network Repository Function (“NRF”) (which provides Network Function (“NF”) service registration and discovery, enabling NFs to identify appropriate services in one another and communicate with each other over Application Programming Interfaces (“APIs”)), a Network Exposure Function (“NEF”) (which is responsible for making network data and resources easily accessible to customers and network partners), or other NFs defined for the 5GC.

In various embodiments, the mobile core network 140 supports different types of mobile data connections and different types of network slices, wherein each mobile data connection utilizes a specific network slice. Here, a “network slice” refers to a portion of the mobile core network 140 optimized for a certain traffic type or communication service. For example, one or more network slices may be optimized for enhanced mobile broadband (“eMBB”) service. As another example, one or more network slices may be optimized for ultra-reliable low-latency communication (“URLLC”) service. In other examples, a network slice may be optimized for machine-type communication (“MTC”) service, massive MTC (“mMTC”) service, Internet-of-Things (“IoT”) service. In yet other examples, a network slice may be deployed for a specific application service, a vertical service, a specific use case, etc.

A network slice instance may be identified by a single-network slice selection assistance information (“S-NSSAI”) while a set of network slices for which the remote unit 105 (or N5CW device) is authorized to use is identified by network slice selection assistance information (“NSSAI”). Here, “NSSAI” refers to a vector value including one or more S-NSSAI values. In certain embodiments, the various network slices may include separate instances of network functions, such as the SMF 145 and UPF 141. In some embodiments, the different network slices may share some common network functions, such as the AMF 143. The different network slices are not shown in FIG. 1 for ease of illustration, but their support is assumed.

The wireless communication system 100 includes an OAM/Management function 130. The OAM/Management function 130 may provide service and/or slice parameters (e.g., service profiles, KPIs, GSTs) to the enabler servers (e.g., VAE-S 163 and/or EES 173). In various embodiments, the OAM/Management function 130 performs slice instantiation, e.g., in response to a request from a service provider.

While FIG. 1 depicts components of a 5G RAN and a 5G core network, the described embodiments for zone configuration and provisioning for VRU protection apply to other types of communication networks and RATs, including IEEE 802.11 variants, Global System for Mobile Communications (“GSM”, i.e., a 2G digital cellular network), General Packet Radio Service (“GPRS”), Universal Mobile Telecommunications System (“UMTS”), LTE variants, CDMA 2000, Bluetooth, ZigBee, Sigfox, and the like.

Moreover, in an LTE variant where the mobile core network 140 is an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 143 may be mapped to an MME, the SMF 145 may be mapped to a control plane portion of a PGW and/or to an MME, the UPF 141 may be mapped to an SGW and a user plane portion of the PGW, the UDM/UDR 149 may be mapped to an HSS, etc.

In the following descriptions, the term eNB/gNB is used for the base station but it is replaceable by any other radio access node, e.g., BS, eNB, gNB, AP, NR, etc. The term “UE” is used for the mobile station/remote unit, but it is replaceable by any other remote device, e.g., remote unit, MS, ME, etc. Further, the operations are described mainly in the context of 5G NR. However, the below described solutions/methods are also equally applicable to other mobile communication systems for zone configuration and provisioning for VRU protection.

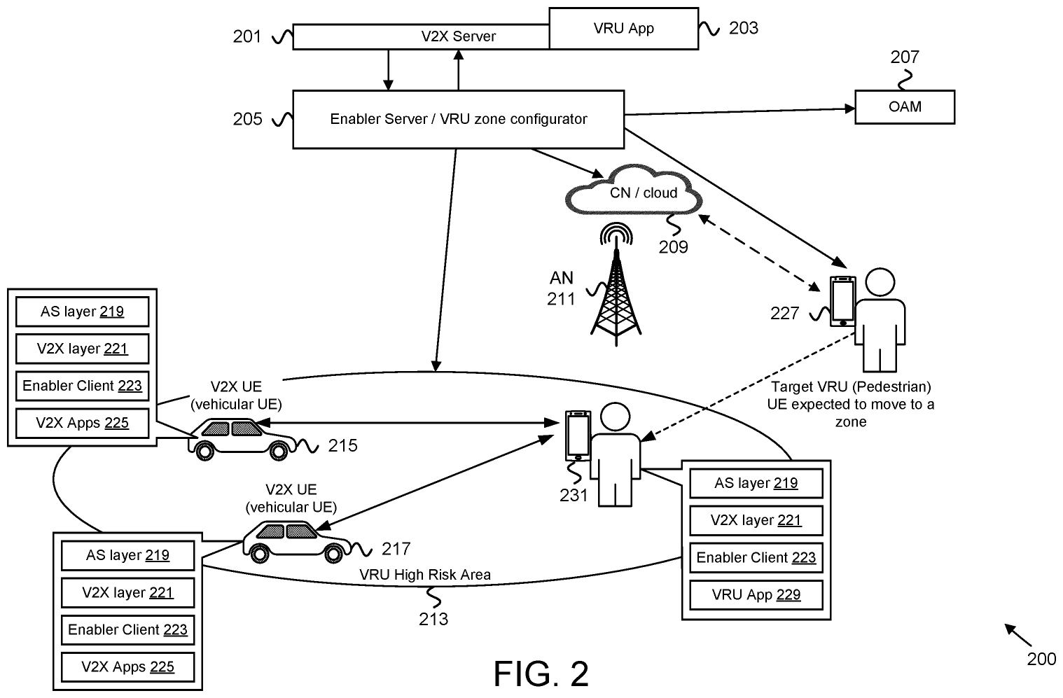

FIG. 2 depicts an example network 200 and mechanism for configuration of VRU high risk zone area and provisioning of V2X UEs and the network with the necessary information for the run-time phase, according to embodiments of the disclosure. The FIG. 2 also depicts signaling for when a VRU device is entering and leaving a high risk zone area. The following descriptions consider two classes of V2x UEs: the vehicular UEs and the VRU UEs, which include pedestrians, UEs within a motorcycle, bicycle, scooter, or other vulnerable vehicle.

In the depicted embodiment, the network 200 comprises a V2X server 201 supporting a VRU application 203, an Enabler server (alternatively, a VRU zone configurator-depicted as combined element “Enabler server/VRU zone configurator” 205), a core network/cloud 209, an Access Network (“AN”) 211, and a plurality of V2X UEs-including a target VRU device 227 and multiple vehicular UEs (e.g., a first vehicular V2X UE 215 and a second vehicular V2X UE 217). Note that in other embodiments the network 200 may include different numbers and/or types of V2X UEs. In various embodiments, the V2X server 201 may be an implementation of the VASS 167 and/or edge application server 177, the Enabler server 205 may be an implementation of the VAE server 163 and/or the Edge Enabler Server 173, the core network/cloud 209 may be an implementation of the mobile core network 140, the AN 211 may a 3GPP RAN and/or a non-3GPP access network, the target VRU device 227 may be an implementation of the VRU device 101 and/or remote unit 105, while the vehicular UEs 215/217 may be implementations of the remote unit 105 and/or the vehicle 161 containing a remote unit 105.

Regarding the mechanism for configuration of VRU high risk zone area 213 and the provisioning of the necessary information, the V2X server 201 may configure a high risk VRU zone area in a static or dynamic manner, as described in greater detail below. The VRU zone configuration may include the geographical area, service area or topological area, a validity time for the zone, and a mobility of the area. For example, the geographical area may change over time to follow a scheduled route, such as that of a school bus.

In some embodiments, the VRU high risk area 213 is initially an application-configured area (e.g., configured by the VRU application), which then needs to be translated to a topological area. As used herein, the topological area refers to the set of cells or other network entities involved with service to a geographical area. Accordingly, the configuration phase (Steps A.1 to A.4) may involve the following steps:

At Step A1, the V2X server 201 provides the high-risk zone configuration to VAE server/middleware, i.e., Enabler server/VRU zone configurator 205.

At Step A2, the Enabler server/VRU zone configurator 205, i.e., the Middleware layer, translates the target area (e.g., geographical area) and parameters to a topological area and attributes.

At Step A3, the Enabler server/VRU zone configurator 205 sends the translated configuration area to VAE/V2X clients within the VRU high risk area 213 as well as to the V2X server 201 and OAM 207 (as notification). As depicted, the first vehicular V2X UE 215 and the second vehicular V2X UE 217 each implement a protocol stack comprising an Access Stratum (“AS”) layer 219, a V2X layer 221, an Enabler client 223, and V2X applications 225. Accordingly, the Enabler server/VRU zone configurator 205 may send the translated configuration area to the enabler clients 223 or to the V2X layer 221.

At optional Step A4, the Enabler server/VRU zone configurator 205—together with the 5GS 509 and/or OAM 207—may instantiate and/or deploy a network slice for this type of area and service (e.g., deploy a VRU high risk slice). Here, the instantiation occurs at the OAM 207, triggered by the Enabler server/VRU zone configurator 205.

During the run-time phase, at Step B, the Enabler server/VRU zone configurator 205 detects a pedestrian UE or vehicular UE that approaches a VRU high risk area 213, depicted here as the target VRU 227 (i.e., a candidate VRU UE). In certain embodiments, detecting the target VRU 227 may be done via UE mobility prediction and profiling of the UE (e.g., UE capabilities, behavior). Note that the predictions/profiling may apply also to groups of pedestrians/vehicles which match the VRU profile (e.g., scooters, bicycles, pedestrians, etc.) and are moving jointly to this VRU high risk area 213.

At Step C1, the Enabler server/VRU zone configurator 205 notifies the V2X server(s) 201 associated with the VRU high risk area 213 about the pedestrian/target VRU 227 which is approaching this VRU high risk area 213.

At Step C2, the Enabler server/VRU zone configurator 205 provides an early notification to the pedestrian/target VRU 227 on the expected high-risk area. The notification to the target VRU 227 may be accomplished in various approaches.

If the target VRU 227 (e.g., pedestrian UE) is registered and connected to the 5GS 209, then the Enabler server/VRU zone configurator 205 may notify the target VRU 227 via the 5GC 209 or, alternatively, via the application layer (e.g., using the VRU application 229) or the enabler layer (e.g., via the enabler client 223). For the network-based notification, the Enabler server/VRU zone configurator 205 may send an AF request to SMF, and after NAS signaling to UE (request the new slice or the new 5QI for target VRU 227). For user-plane notification, the Enabler server/VRU zone configurator 205 may trigger a slice remapping/QoS profile change, and at the same time the VRU application(s) 229 are activated.

If the target VRU 227 is registered but not connected to the 5GS 509, the Enabler server/VRU zone configurator 205 may trigger a PDU session establishment with requested slice/QoS. However, if the target VRU 227 is not registered and not connected to the 5GS 209 but connected to a non-3GPP access, the Enabler server/VRU zone configurator 205 may use the (non-3GPP) access network 211 to deliver the notification and trigger registration/connection to the 5GS 209.

At Step D, after the action from the target/candidate VRU 227 (to establish or update the connection), the V2X layer 221 may instantiate a VAE client (i.e., enabler client 223) at the target VRU 227, if not already instantiated, and/or activate a VRU application 229 (or instantiate the VRU application 229 if not already instantiated). Optionally, the target VRU 227 may receive the configuration related to the VRU high risk zone 213, via the Enabler server/VRU zone configurator 205 or via the V2X server 201 or via the access network 211 (i.e., broadcasted in SIB).

Note that in some embodiments, a target/pedestrian UE may not be VRU capable. In such embodiments, the Enabler server/VRU zone configurator 205 may select another VRU-enabled device or V2X UE to support the configuration and VRU parameters provisioning on behalf of the non-capable UE. This step will involve the attachment of the pedestrian UE to the remote VRU application at the other UE.

At Step E, the Enabler server/VRU zone configurator 205 tracks the location of the target VRU 227. When the target VRU 227 enters the VRU high risk area, the Enabler server/VRU zone configurator 205 triggers the V2X server 201 to send V2X messages (e.g., VAM message, PSM message, etc.) in case of unicast communication. Optionally, the Enabler server/VRU zone configurator 205 may also trigger the addition of the target VRU 227 to a VRU cluster. In the depicted embodiment, the target VRU 227 becomes the VRU 231 upon entering the VRU high risk area 213.

At Step F, when a V2X UE (e.g., either vehicular UE 215/217 or VRU 231) is leaving the area or expected to leave the area, then the Enabler server/VRU zone configurator 205 may notify the identified UE, the V2X server 201, and the 5GS 209 of the event. Additionally, the Enabler server/VRU zone configurator 205 may remove the leaving V2X UE from a VRU cluster and/or a list of VRU UEs, and further release/remove connections related to VRU communication.

The V2X Application Enabler (“VAE”) layer provides some initial support functionalities for V2X use cases, e.g., to ensure efficient use and deployment of V2X services over 3GPP systems. This VAE layer comprises a VAE server (“VAE-S”) at the network side, which may be either a PLMN-owned or provided by a third-party/vertical server, and one or more VAE clients (“VAE-C”) at the UE side. The VAE server is a middleware platform that provides support functionalities to the enabler clients and interacts with the application specific servers (e.g., platooning server) as well as with the involved PLMNs, to ensure meeting the per vertical requirements.

Accordingly, the VAE server may provide server-side V2X application layer support functions, including (but not limited to):
communicating with the underlying 3GPP network system (EPS, 5GS) for unicast and multicast network resource management;
receiving monitoring reports/events from the underlying 3GPP network system (EPS, 5GS) regarding network situation corresponding to RAN and core network;
supporting registration of V2X UEs;
tracking the application level geographic location of the V2X UEs;
supporting V2X message distribution for the V2X applications;
supporting provisioning of 3GPP system configuration information (e.g., V2X USD, PC5 parameters);
perform the role of content provider for multicast file transfer using xMB APIs;
providing network monitoring reports to the V2X UEs;
communicating V2X service requirements to the underlying 3GPP network system (EPS, 5GS);
maintaining the mapping between the V2X user ID and the V2X UE ID;
providing V2X service discovery;
supporting V2X service continuity; and
supporting V2X application resource adaptation.

Similarly, the VAE client may provide UE-side V2X application layer support functions, including (but not limited to):
registration of VAE clients for receiving V2X messages;
receiving V2X messages from the VAE server and the delivery to V2X application specific client(s) according to the V2X service ID;
perform the role of the MBMS client for multicast file transfer using xMB APIs;
receiving network monitoring reports from the VAE server;
supports switching the modes of operations for V2V communications (e.g., between direct and in-direct V2V communications);
providing application level locations to the VAE server (e.g., tile, geo-fence);
receiving 3GPP system configuration information (e.g., V2X USD, PC5 parameters) from the VAE server; and
supporting dynamic group management.
supports interactions with the V2X application specific client(s).

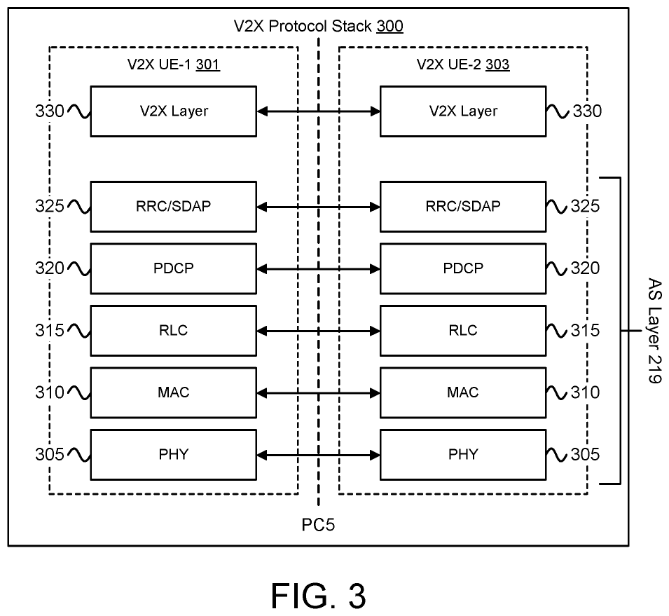

FIG. 3 depicts a V2X protocol stack 300, according to embodiments of the disclosure. While FIG. 3 shows the UE-1 301 and the UE-2 303, these are representative of a set of V2X UEs and other embodiments may involve different V2X UEs. As depicted, the V2X protocol stack (i.e., PC5 protocol stack) includes a physical (“PHY”) layer 305 (also known as Layer-1 or “L1”), a MAC sublayer 310, a RLC sublayer 315, a PDCP sublayer 320, and Radio Resource Control (“RRC”) and Service Data Adaptation Protocol (“SDAP”) layers (depicted as combined element “RRC/SDAP” 325), for the control plane and user plane, respectively. The V2X layer 330 is above the RRC/SDAP layer 325.

The AS layer 219 (also referred to as “AS protocol stack”) for the control plane in the PC5 interface consists of at least RRC, PDCP, RLC and MAC sublayers, and the physical layer. The AS layer 219 for the user plane in the PC5 interface consists of at least SDAP, PDCP, RLC and MAC sublayers, and the physical layer. The Layer-2 (“L2”) is split into the SDAP, PDCP, RLC and MAC sublayers. The Layer-3 (“L3”) includes the RRC sublayer and the NAS layer for the control plane and includes, e.g., an Internet Protocol (“IP”) layer for the user plane. L1 and L2 are referred to as “lower layers,” while L3 and above (e.g., transport layer, V2X layer, application layer) are referred to as “higher layers” or “upper layers.”

Similar to the NR protocol stack, the physical layer 305 offers transport channels to the MAC sublayer 310. The MAC sublayer 310 offers logical channels to the RLC sublayer 315. The RLC sublayer 315 offers RLC channels to the PDCP sublayer 320. The PDCP sublayer 320 offers radio bearers to the SDAP sublayer. The SDAP sublayer offers QoS flows to upper layers (i.e., V2X layer 330).

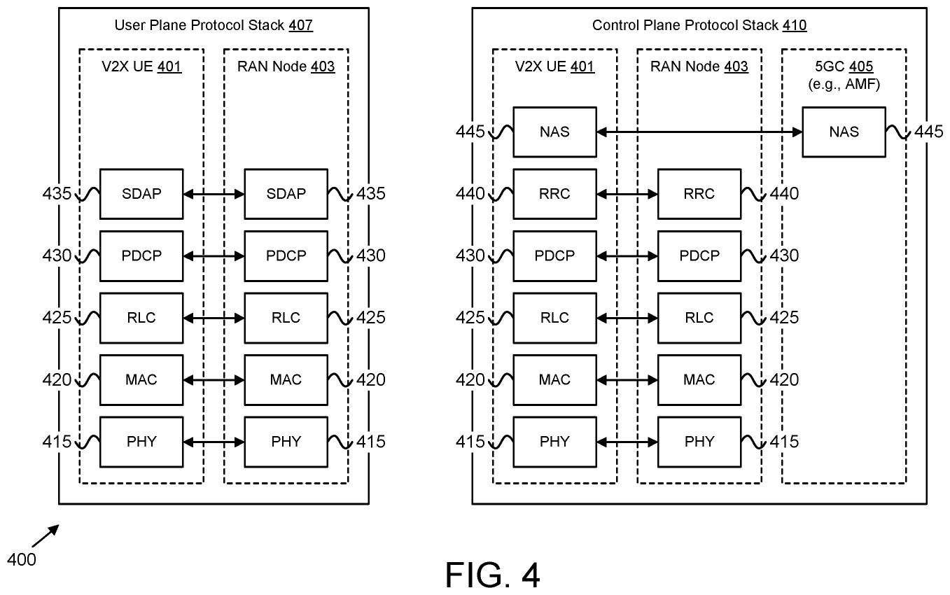

FIG. 4 depicts a NR protocol stack 400, according to embodiments of the disclosure. While FIG. 4 shows the V2X UE 401, a RAN node 403 and a 5G core network (“5GC”) 405, these are representative of a set of remote units 105 interacting with a base unit 121 and a mobile core network 140. As depicted, the protocol stack 400 comprises a User Plane protocol stack 407 and a Control Plane protocol stack 410. The User Plane protocol stack 407 includes a physical (“PHY”) layer 415, a Medium Access Control (“MAC”) sublayer 420, the Radio Link Control (“RLC”) sublayer 425, a Packet Data Convergence Protocol (“PDCP”) sublayer 430, and Service Data Adaptation Protocol (“SDAP”) layer 435. The Control Plane protocol stack 410 includes a physical layer 415, a MAC sublayer 420, a RLC sublayer 425, and a PDCP sublayer 430. The Control Plane protocol stack 410 also includes a Radio Resource Control (“RRC”) layer 440 and a Non-Access Stratum (“NAS”) layer 445. Note that the NAS layer 445 comprises a NAS 5G Mobility Management (“5GMM”) sub-layer 465.

The AS layer (also referred to as “AS protocol stack”) for the User Plane protocol stack 407 consists of at least SDAP, PDCP, RLC and MAC sublayers, and the physical layer. The AS layer for the Control Plane protocol stack 410 consists of at least RRC, PDCP, RLC and MAC sublayers, and the physical layer. The Layer-2 (“L2”) is split into the SDAP, PDCP, RLC and MAC sublayers. The Layer-3 (“L3”) includes the RRC sublayer 440 and the NAS layer 445 for the control plane and includes, e.g., an Internet Protocol (“IP”) layer and/or PDU Layer (not depicted) for the user plane. L1 and L2 are referred to as “lower layers,” while L3 and above (e.g., transport layer, application layer) are referred to as “higher layers” or “upper layers.”

The physical layer 415 offers transport channels to the MAC sublayer 420. The physical layer 415 may perform a Clear Channel Assessment and/or Listen-Before-Talk (“CCA/LBT”) procedure using energy detection thresholds, as described herein. In certain embodiments, the physical layer 415 may send a notification of UL Listen-Before-Talk (“LBT”) failure to a MAC entity at the MAC sublayer 420. The MAC sublayer 420 offers logical channels to the RLC sublayer 425. The RLC sublayer 425 offers RLC channels to the PDCP sublayer 430. The PDCP sublayer 430 offers radio bearers to the SDAP sublayer 435 and/or RRC layer 440. The SDAP sublayer 435 offers QoS flows to the 5GC 405 (i.e., UPF 141). The RRC layer 440 provides for the addition, modification, and release of Carrier Aggregation and/or Dual Connectivity. The RRC layer 440 also manages the establishment, configuration, maintenance, and release of Signaling Radio Bearers (“SRBs”) and Data Radio Bearers (“DRBs”).

The NAS layer 445 is between the V2X UE 401 and the 5GC 405 (i.e., AMF 143). NAS messages are passed transparently through the RAN. The NAS layer 445 is used to manage the establishment of communication sessions and for maintaining continuous communications with the V2X UE 401 as it moves between different cells of the RAN. In contrast, the AS layer is between the V2X UE 401 and the RAN (i.e., RAN node 403) and carries information over the wireless portion of the network.

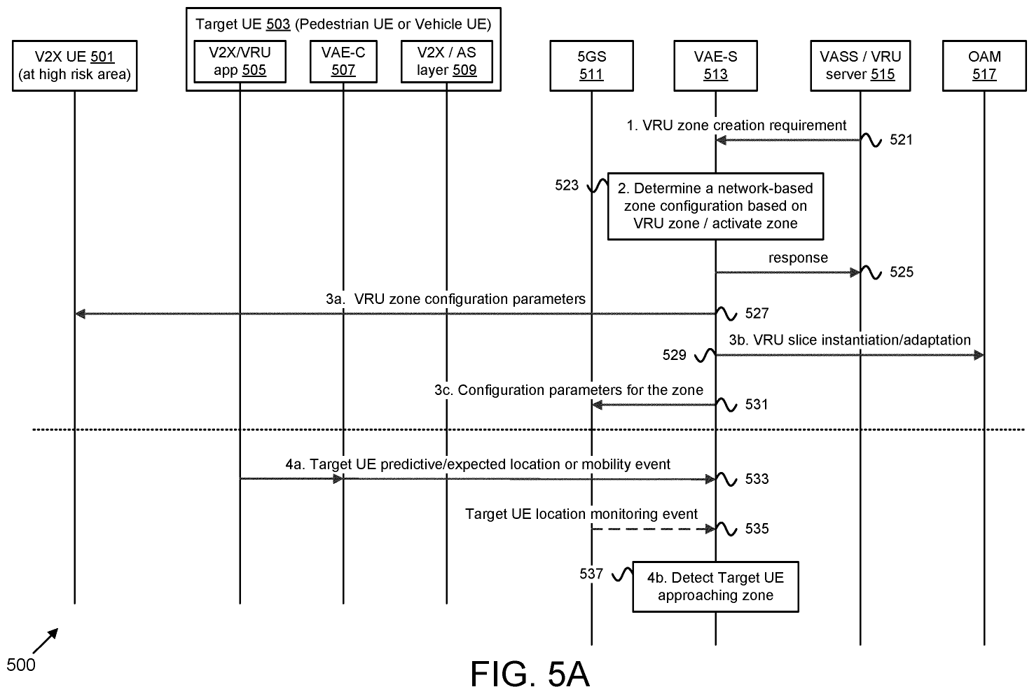

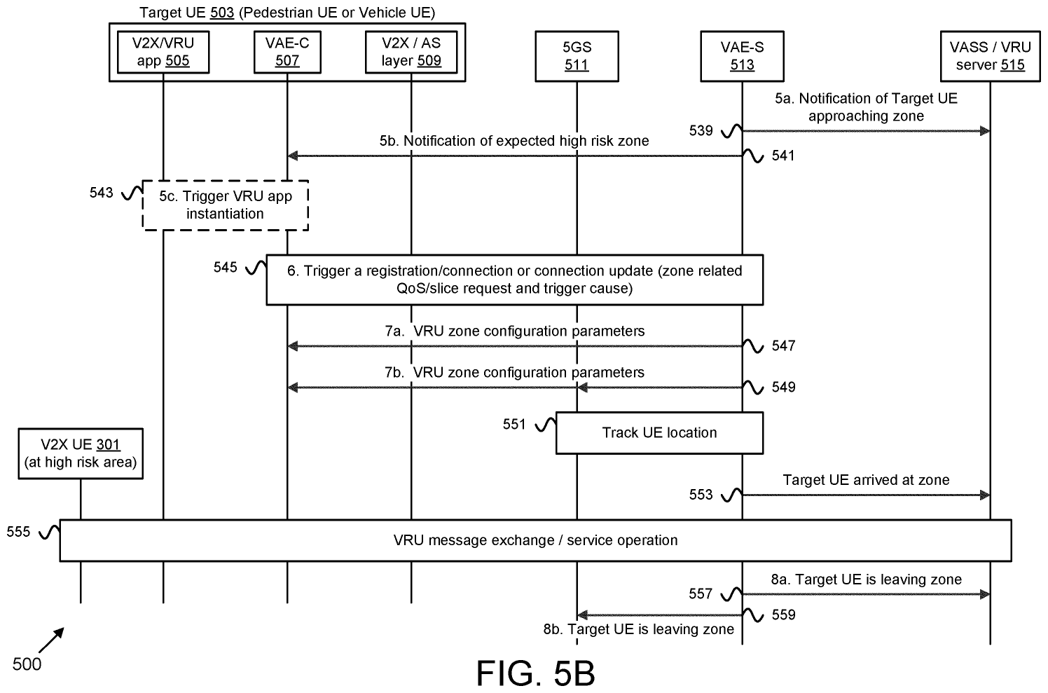

FIGS. 5A-5B depict a procedure 500 for the configuration and provisioning of the VRU high risk zone, according to embodiments of the disclosure. The procedure 500 involves a V2X UE 501 located in the high risk area, a target UE 503 (e.g., a pedestrian UE or vehicular UE), a 5GS 511 (e.g., comprising a 5G core network (“5GC”) and compatible RAN), a VAE server (“VAE-S”) 513, a V2X Application-Specific Server (“VASS”) or VRU server (depicted as combined element “VASS/VRU server” 515), and OAM 517. The V2X UE 501 may be one embodiment of the remote unit 105, the VRU device 101, the remote unit 105, the vehicle 161, the V2x UE 215, the V2X UE 217, the VRU 231, the V2X UE-1 301, the V2X UE-2 303, and/or the V2X UE 401. The target UE 503 may be one embodiment of the remote unit 105, the VRU device 30 101, the remote unit 105, the vehicle 161, the target VRU 227, the V2X UE-1 301, the V2X UE-2 303, and/or the V2X UE 401. The 5GC 511 may be one embodiment of the mobile core network 140, the core network/cloud 209, and/or the 5GC 407. The VAE-S 513 may be one embodiment of the VAE sever 163 and/or the Enabler Server/VRU Zone Configurator 205. The VASS/VRU 515 may be one embodiment of the VASS 167, and/or the V2X Server 201. The OAM 517 may be one embodiment of the OAM/Management Function 130.

In the embodiments of FIGS. 5A-5B, the middleware layer which supports the configuration and provisioning of the VRU high risk zone is an application enabler server, which has a client counterpart at the UE side. Such enabler server can be a V2X specific enabler (e.g., VAE server 513) or could be also a Service Enabler Architecture Layer (“SEAL”) server or other type of enabler server (e.g., edge enabler server).

At Step 1, the VASS/VRU server 515 sends a requirement which is to create a new high-risk area zone (see messaging 521), and requires the VAE-S 513 support to translate it to a network-related zone configuration and provisioning to UEs within the requested area. The requirement message includes one or more of the following parameters:
Requestee ID (VASS ID, App ID),
VRU zone type (based on the scenario, which type of UEs are to be considered),
Clustering flag and parameters (whether clustering can be done to minimize signaling),
geographical area,
time validity,
time initiation,
RAT/interfaces to be used with the zone,
types of supported messages and requirements (e.g., requirements for VAM messages),
RSU/BS support indication,
energy efficiency support (to take into account the energy/battery consumption of the UE),
northbound API exposure requirement for the zones and permissions based on the type of the UE (here, the northbound API is an interface that facilitates communication with a higher level component, i.e., using the component's southbound interface)
allowed actions by the VAE-S 513,
QoS and/or slice requirement dedicated for the VRU zone (e.g., URLLC like),
allowed V2X services/service types to be used within the VRU zone,
DRX configuration over PC5 (if UEs are out of coverage)

Note that if the zone is dynamically changing based on an event (e.g., school bus mobility/route), such mobility/route information will be provided to the VAE-S 513, or the VASS/VRU server 515 needs to provide new configuration every time the configuration changes

At Step 2, the VAE-S 513 translates the zone requirement and determines a set of network-related zone parameters (see block 523). Here, the parameters indicate:
the topological area for the zone (cell IDs, TAs),
the QoS requirements within the zone,
the network function and exposure requirements within the zone,
the value added services required within the zone (e.g., location tracking, V2X message bundling),
the transmission modes (unicast, groupcast, broadcast) within the applications within the zone,
the interface selection within the zone (Uu, PC5 ),
the use of UE relaying or not,
whether the zone is dynamic or not, and if it is dynamic to take into account the configuration adaptation every time the configuration changes or to provide the planning (e.g., based on a school bus route) to allow the network to adapt the configuration.

Optionally after step 2 (or before), a response is sent to the VASS as acknowledgement (see messaging 525).

At Step 3a, the VAE-S 513 sends a message including the VRU zone configuration parameters (see messaging 527). Here, the message may be broadcast, groupcast or unicast (i.e., using multiple unicast links). Parameters may be a combination of the parameters received in Step 1 as well as parameters determined in Step 2. This configuration will be provided to the V2X-UEs (and pedestrians) within the area that will be covered by the VRU zone, and will also indication when the zone will be activated, for how much time and if the zone configuration will be dynamically changing (e.g., where a school bus moves) and parameters related to the dynamicity (as discussed in Steps 1 and 2).

At Step 3b, the VAE-S 513, if the VRU zone requires the instantiation of a new slice which is tailored to this service in this area, requests the management domain (e.g., OAM 517) to instantiate a new slice and provides the service profile/requirements for such instantiation (see messaging 529). Such instantiation will be done by the OAM 517 and a positive response will follow with slice parameters for the slice creation (e.g., capabilities, slice coverage, configurations, permissions, etc.). Such exposure from the OAM 517 may happen via EGMF/OSS directly, or via BSS.

At Step 3c, the VAE-S 513 sends the configuration parameters related to the 5GS 511 (e.g., to PCF 147) for the zone creation (see messaging 531). Such parameters may be one or more of the following:

For communication over Uu, the VAE-S 513 provides information for setting up policies for a future communication within the high-risk zone. Here, the policies and corresponding information may include:
Area of interest (geographical (coordinates, civic/street addresses) or topological, e.g., cell IDs, or DN service area)
Application ID and type,
UE ID (e.g., GPSI) and IP address, group ID, slice ID, DNN (if the target UE is known and the zone is dynamic)
Time of validity for the zone
Time duration, expected start/finish times,
Zone ID, Zone type (static, dynamic),
A maximum number of active UEs/VRUs within the zone,
Supported UE types (pedestrian/VRU, V2X UE), and
Service profile/app QoS requirements per UE type

Alternatively (or additionally) the VAE-S 513 may provide pre pre-configured provisioning policies/parameters for the zone, such as QoS parameters and/or radio parameters, such as those defined in 3GPP TS 23.287. Here, the provisioning may be provided by an application function (“AF”) to PCF (e.g., PCF 147) and the PCF applies the provisioning policies.

The VAE-S 513 subscribes to be notified when a UE enters the high-risk zone area (analytics may also be used). When a UE enters high risk zone area the VAE-S 513 requests the network to establish an AF session with specific QoS. Within the request the VAE-S 513 provides QoS requirements, slice etc.
AF ID/VAE server ID,
Zone ID,
Cause for zoning,
List of UEs and IP addresses,
UE types (pedestrian, vehicular) and context,
QoS requirements for the zone area,
slice requirements for the zone area,
API exposure requirement/subscription for monitoring events (e.g., analytics),
validity/time of start for the request,
area of zone coverage (cell IDs, geographical area),
mobility/route of the UE/group of interest (e.g., school bus)

For communication over side-link (can be provided as pre-configuration or dynamically based on the zone type), VAE-S 513 provides a V2X configuration to the UE that includes:
Validity information (zone area, validity time),
Allowed v2x services/v2x service types,
QoS requirements (mapping of V2X service type to a specific QoS),
PC5 DRX parameters (mapping of V2X service type to a specific DRX,
List of supported PQIs within the zone,
Radio parameters for Out-of-Coverage (“OOC”) (e.g., TxResourcePools, RxResourcePools) for VRUs and V2X UE per zone

The VAE-S 513 may also provide configuration parameters to OAM that is further provided to a PCF. The configuration parameters include the information provided directly to the UE. Once the PCF receives the configuration the PCF provides updated V2X configuration information to the UE via NAS signaling.

At Step 4a, the application of target UE 503 (or VAE client 507 or SEAL LMS client) or other UEs on behalf of the target UE 503 may send a UE mobility event (or expected/predicted event) to VAE-S 513, indicating the mobility/handover to a target geographical or topological area (see messaging 533). As another option, the VAE client 507 may subscribe to the AS Layer of the target UE 503 to receive a notification on an expected/predicted handover to a neighboring RAN node.

Alternatively, the UE mobility event may be exposed by 5GC (LMF/GMLC), based on subscription (see target UE location monitoring event reported by 5GS, see messaging 535). Note that the run-time phase begins with Step 4a.

At Step 4b, the VAE-S 513 translates the target UE 503 mobility event to an expected entrance to a VRU high risk zone, and based on the configuration of the zone, it identifies when an action needs to be taken and when to communicate this with the involved application and network entities (see block 537).

Continuing on FIG. 5B, at Step 5a, the VAE-S 513 alerts the VASS that the target UE 503 is expected to move to the VRU zone area in X time and also provides information on its mobility as well as the capabilities (e.g., VRU capable) and optionally the battery status (see messaging 539). Note that the battery status can be requested by the target UE 503 or can be queried by the VAE-S 513 as a separate interaction, or can be calculated based on analytics from application layer if the initial battery status is known and the ongoing services/usage is known. The notification/alert message may include the UE ID (GPSI, or external ID), the group ID (if it is a group of UEs), a VRU candidate flag, an expected start time of VRUP, an expected duration, UE context information, expected mobility/speed/direction, etc.

At Step 5b, the VAE-S 513 may also alert the VAE client (if deployed at the target UE 503) that it is expected to enter the VRU zone and requests the confirmation for allowing the push of VRU messages within the zone (see messaging 541). Such notification/request will include zone area information and configuration (or this can be provided after the response from the VAE client 507 and Step 5c).

At Step 5c, the VAE client 507 (optionally, if needed) interacts with V2X Application Specific Client (“VASC”) to instantiate/activate a VRU related application 505 (this can be an alert to the pedestrian's smartphone to open the VRU application 505 so as to receive notifications (see block 543). In various embodiments, the VAE client 507 may send a confirmation/acknowledgement (not shown) before or after Step 5c.

At Step 6, the VAE client 507 or VAE-S 513 interacts with the NAS layer to trigger a network related action for the target UE 503 (see block 545). If the target UE 503 is registered and connected to 5GS there are three alternatives:

Alternative 1, the target UE 503 triggers a connection capabilities update and modifies the connection via NAS signaling, e.g., QoS and/or slice (UE-based approach).

Alternative 2, for the network-based connection update trigger, the VAE-S 513 to sends an AF request to the SMF (e.g., SMF 145), and after NAS signaling to the target UE 503 (i.e., request the new slice for target UE 503).

Alternative 3, for user-plane connection update trigger (network-based), the target UE 503 trigger a slice remapping/QoS profile change via the enabler layer, and then the VAE-S 513 interacts as AF with SMF 145 via NEF 148 to apply the requested changes:
If the target UE 503 is registered but not connected to 5GS 511, trigger a PDU session establishment with requested slice/QoS.
If the target UE 503 is not registered and not connected to 5GS 511 but connected to non-3GPP access, use non-3GPP access to trigger registration/connection to 5GS 511.

For Step 7, either Step 7a or Step 7b is performed, depending on the specific implementation.

At Step 7a, the VAE-S 513 sends the VRU zone configuration parameters to the target UE 503 via VAE layer connection (see messaging 547).

At Step 7b, the VAE-S 513 sends the VRU zone configuration parameters to the target UE 503 via NAS signaling (see messaging 549).

The VRU zone configuration parameters may be any combination of the parameters which were provided in Step 3a, and will allow the target UE 503 to receive/transmit VRU messages within the zone.

The 5GS 511 and VAE-S 513 track the location of the target UE 503 (see block 551). Upon entry of the target UE 503 to the VRU zone, the VAE-S 513 notifies the VASS/VRU server 515 (see messaging 553). Subsequently, the target UE 503 is within the zone and the service operation is ongoing (see block 555).

At Step 8, when the target UE 503 is leaving the zone (based on configuration, his location may be tracked via 5GC or via the enabler client), a message may be sent to the VASS/VRU server 515 (see messaging 557) and/or to the 5GC 511 (see messaging 559) to notify that the target UE 503 is expected to leave this area and the VRUP is no longer needed. This will trigger the connection update or termination and the application de-activation/erase of app context.

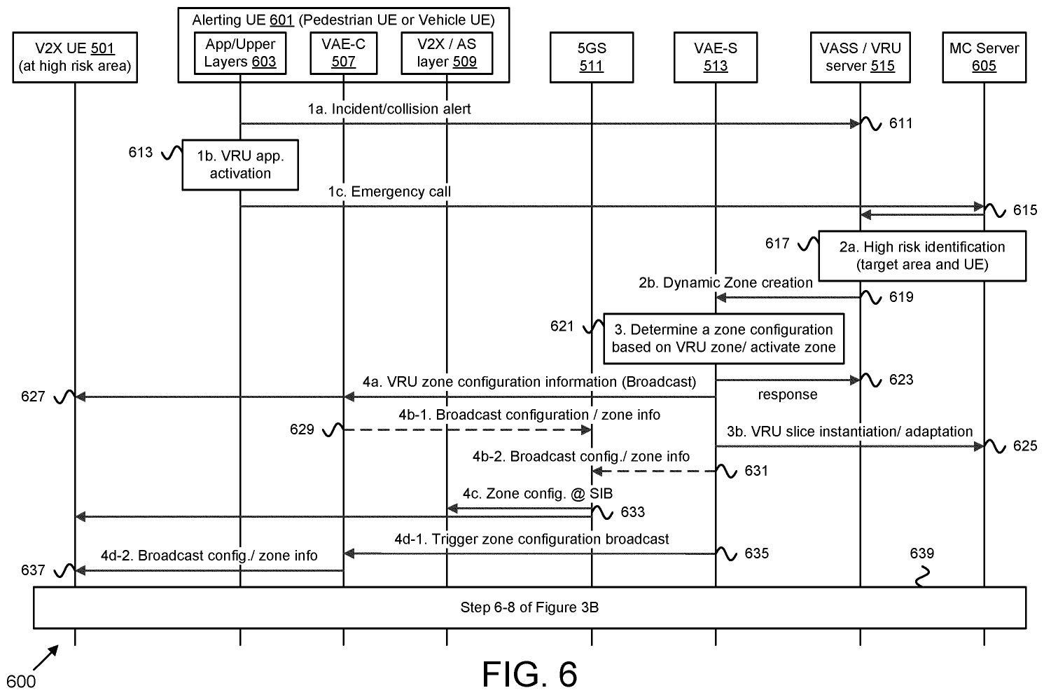

FIG. 6 depicts a procedure 600 for dynamic zone creation, according to embodiments of the disclosure. The procedure 600 involves the V2X UE 501, an alerting V2X UE 601, the 5GS 511, the VASE-S 513, the VASS/VRU server 515, and a Mission Critical (“MC”) server 605. Note that the alerting UE 601 contains an application layer and upper layers (depicted as combined element 603).

The procedure 600 depicts a dynamic event which may be an emergency, and which triggers dynamic zone activation to avoid hazards for the pedestrians, and in particular when a UE which is inside a vehicle (not considered VRU) is required to leave the vehicle in a potentially hazardous area, thus transforming into a VRU UE. Such scenario can be for the case of a vehicle collision and/or a highway incident which necessitates a user/UE to leave the vehicle, but at the same time other vehicles may be approaching this area at speed. In this case, the dynamic zone activation mitigates the risk of a further collision/incident between the disembarked UE (now considered a VRU) and the approaching vehicles (e.g., having vehicular UEs).

At Step 1a, the alerting V2X UE 601 detects an emergency incident (e.g., car failure, collation, etc.) and notifies the V2X server (e.g., VASS/VRU server 515—see notification 611). This notification 611 can be a form of an incident/collision alert to the VASS/VRU server 515 (or to the VAE server 513). Note that in some embodiments the alerting UE 601 may be the UE of an occupant (e.g., passenger) of a vehicle having its own UE (e.g., a car and its passenger may have different UEs and/or SIM cards). In such embodiments, the alert may indicate both the UE ID of vehicle UE and the passenger's smartphone/UE.

Step 1b is an alternative to Step 1a. At Step 1b, the alerting V2X UE 601 activates a VRU application at the smartphone (i.e., UE) of the car driver (see block 613), e.g., to notify the surrounding vehicles of the detected emergency incident, as well as to receive notifications for approaching vehicles (e.g., fast approaching cars). As discussed above, the alerting vehicle may comprise a V2X UE that is different than a passenger's UE. In such case, the vehicle V2X UE may interact with the passenger's UE to allow the activation/instantiation of a VRUP application at the passenger's UE. The necessary parameters for activation of this VRU application include the passenger UE ID, the V2X UE ID (e.g., where different than the UE ID), the VRUP application profile and the time/area of validity for this activation.

At Step 1c, an occupant of the alerting vehicle makes an emergency call to notify on the accident (see messaging 615). Such emergency call goes to the MC server 605 (e.g., a Mission-Critical Push-To-Talk (“MCPTT”) server or another MC-related server (e.g., MCData server)). The MC server 605 interacts with the VASS/VRU server 515 to notify of the emergency call and set up a dynamic high risk zone area.

At Step 2a, the VASS/VRU server 515 identifies the need of a high-risk zone based on the alerting UE 601 and defines an area/radius around the alerting UE 601 where the VRU zone will apply (see block 617). For example, the VASS/VRU server 515 may create a zone having a 50 m radius and centered on the alerting UE 601/alerting vehicle. The configuration of the radius/area of the zone can be based on multiple factors, such as the environment (e.g., on a highway the radius is expected to be larger due to higher speeds of the traveling vehicles), the type of incident, whether the VRU is expected to be just one UE or a group of UEs, analytics on the needed minimum area based on the event, the communication range of the UE and the capabilities (allowed interfaces).

At Step 2b, the VAE server 513 receives the requirement for the alerting V2X UE 601 by the V2X server 513, and optionally receives the requirement for a new dynamic zone creation (see messaging 619).

At Step 3, the VAE server 513 determines the zone parameters and creates a dynamic zone (see messaging 621). These parameters can be network-related translated parameters (as described in Step 2 of FIG. 5A) and/or application-layer zone parameters (as described in Step 1 of FIG. 5A1). Optionally after step 3 (or before), a response is sent to the VASS/VRU server 515 as acknowledgement (see messaging 623).

At Step 3b, the VAE server 513, if the dynamic high risk zone requires the instantiation of a new slice which is tailored to this service in this area, requests the management domain (e.g., OAM) to instantiate a new slice and provides the service profile/requirements for such instantiation (see messaging 625), as discussed above with reference to FIG. 5A.

The procedure 600 considers three alternative options for providing the zone information to relevant UEs (e.g., vehicular UEs and/or Pedestrian/VRU UEs).

Option 1 corresponds to Step 4a. Here, the VAE server 513 broadcasts the zone information via VAE layer to all VAE clients 507 with the given area (see messaging 627). The zone information indicates a dynamic high risk zone configuration due to an accident, the cause, and the required actions within this zone. Due to the dynamicity of the creation, this dynamic high risk zone will only provide the necessary alerts to either the VRU UE and/or the high-speed vehicles within the zone or approaching the zone, or in case of further VRUs in the area the broadcast of alerts to all of them.

Option 2 corresponds to Steps 4b-1/4b-2 and Step 4c. At Step 4b-1, the VAE client 507 of the alerting UE 601 requests (see messaging 629) one or more 5GSs to broadcast the zone information via System Information Block (“SIB”) to all UEs within the dynamic high risk zone.

Alternatively, at Step 4b-2 the VAE server 513 requests (see messaging 631) one or more 5GSs to broadcast the zone information (e.g., via SIB) to all UEs within this dynamic high risk zone area. More specifically, the VAE server 513 (i.e., acting as an AF) provides the provisioning parameters for the identified zone and indicate that the zone information is to be broadcasted in SIB.

At Step 4c, a core network function of the 5GC 511 (e.g., PCF) will provide this zone information to the RAN (e.g., via AMF), and the RAN will provide (i.e., broadcast) this zone information in a specific SIB (see broadcast 633). Such zone information is to include the area and time of validity, the Tx/Rx resource pools to be used within this zone, the DRX timings/configuration within the zone, the list of PQIs/5QIs, the supported interfaces (PC5, Uu), the possible use of relays and RSUs within the zone (in case of RSUs, the list of RSU IDs and access information/type of relaying).

Note that broadcasting the zone information can be done via the PLMN of the alerting UE 601 or via multiple PLMN within the area, based on the scenario. The alerting UE 601 as well as the other UEs within the new zone (i.e., V2X UE 501) are notified and apply the requested information. In case of broadcasting, the RAN is also providing the zone information as part of the SIB.

Option 3 corresponds to Steps 4d-1 and 4d-2. In this alternative, the VAE server 513 requests (see messaging 635) one or more connected VAE clients 507 (e.g., of the alerting UE 601 and V2X UE 501) in the zone area to broadcast the zone information (see messaging 637) to all other UEs within the reach of the VAE clients acting as application relays for the zone information provisioning.

The procedure 600 completes by triggering a connection (or connection update), providing VRU zone configuration parameters, and handling UE entry into and leave from the new zone, as described in Steps 6-8 of FIG. 5B (see block 639).

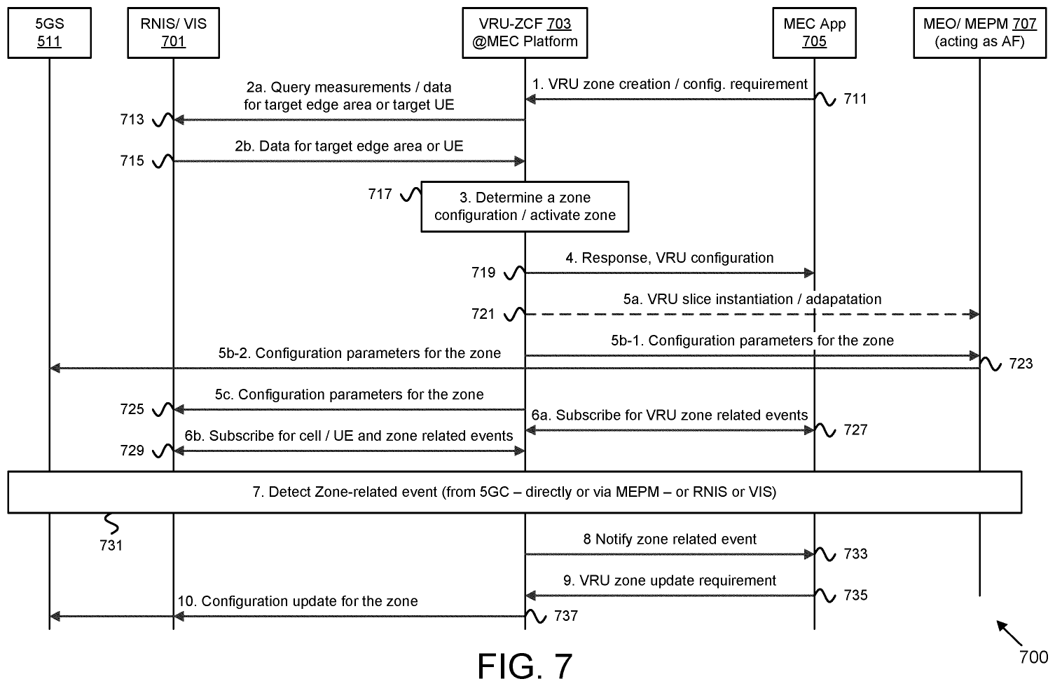

FIG. 7 depicts a procedure 700 for MEC-platform enabled zone configuration and provisioning, according to embodiments of the disclosure. The procedure 700 involves the 5GS 511, a Radio Network Information Service (“RNIS”) function and/or V2X Information Services (“VIS”) function (depicted as combined element “RNIS/VIS” 701), a VRU Zone Configuration Function (“VRU-ZCF”) 703 (located at a Multi-Access Edge Computing (“MEC”) platform, a Multi-Access Edge Computing Application (“MEC App”) 705 and a MEC Orchestrator and/or MEC Platform Manager, e.g., an management domain entity acting as an Application Function (“AF”) (depicted here as combined element “MEO/MEPM” 707). The VRU-ZCF 703 may be one implementation of the enabler server/VRU zone configurator 205, while the MEC App 705 may be one embodiment of the VRU App 203, as described above.

Note that ETSI MEC allows the exposure of APIs from RAN to MEC platforms. The exposure of APIs from UE/RAN to the service provider may relate to the UE location information, Bandwidth management, Radio Network Information (“RNI”).

Radio Network Information Service (“RNIS”) is a service that provides radio network related information to MEC applications and to MEC platforms. The granularity of the radio network information may be adjusted based on parameters such as information per cell, per User Equipment, per QoS class or it may be requested over period of time. The Radio Network Information may be used by the MEC applications and MEC platform to optimize the existing services and to provide new type of services that are based on up to date information on radio conditions.

V2X Information Services (“VIS”) is a MEC service relates to V2X use cases. The VIS aims to facilitate V2X interoperability in a multi-vendor, multi-network and multi-access environment. Some functionalities of the VIS include:
Gathering of PC5 V2X relevant information from the 3GPP network (e.g., the list of authorized UEs, the relevant information about the authorization based on the UE subscription and the relevant PC5 configuration parameters),
Exposure of this information to MEC apps (also potentially belonging to different MEC systems),
Enablement of MEC apps to communicate securely with the V2X-related 3GPP core network logical functions (e.g., V2X control function),
Enablement of MEC apps in different MEC systems to communicate securely with each other, and
Gathering and processing information available in other MEC APIs

In the embodiments of FIG. 7, the functions which support the configuration and provisioning of the VRU high risk zone, includes MEC platform capability. Accordingly, the VRU-ZCF 703 may comprise different implementations of a MEC platform function, such as an enhanced VIS functionality, an enhanced RNIS functionality, and/or a new MEC functionality.

At Step 1, the MEC App 705 sends a requirement to the VRU-ZCF 703 which is to create a new high-risk zone for a target area and requires the MEC platform support to translate the application-level requirement into a VRU zone configuration within the requested area (see messaging 711). The requirement message consists of one or more of the following parameters:

A) Requestee ID (e.g., MEC App ID), B) VRU zone type (based on the scenario, which type of UEs are to be considered), C) a Clustering flag (e.g., indicating whether clustering can be done to minimize signaling) and clustering parameters, D) Geographical area, E) Time validity, F) Time initiation, G) RAT/interfaces to be used with the zone, H) Types of supported messages and requirements (e.g., requirements for VAM messages), I) RSU/BS support indication, J) energy efficiency support (to take into account the energy/battery consumption of the UE), K) MEC API exposure requirement for the zones and permissions based on the type of the UE, L) QoS and/or slice requirement dedicated for the VRU zone (e.g., URLLC like), M) Allowed V2X services/service types to be used within the VRU zone, and N) DRX configuration over PC5 (if UEs are out of coverage).

At Step 2a, the VRU-ZCF 703 queries the RNIS/VIS 701 for data and/or measurements for the target edge area (i.e., the target VRU zone) (see messaging 713). These data/measurements may include L2 measurements, radio bearer status/events monitoring, V2X-specific data (e.g., configurations, radio parameters, CBR measurements) for sidelink and Uu interfaces.

At Step 2b, the VRU-ZCF 703 receives the requested data/measurements from the RNIS and/or VIS (see messaging 715). The data received from the VIS may include, but is not limited to: Uu provisioning information for a given area, PC5 provisioning information for a given area, and QoS prediction for a given time and area.

The data/measurements received from the RNIS may include, but is not limited to: A) Layer-2 measurements (“L2meas”), e.g., from one or more RAN entities associated with the MEC App 705; B) Radio Access Bearer information (“RABinfo”), e.g., for radio bearers associated with the MEC App 705; C) 5G UE measurement report notifications for UEs served by NR Cells (“NrMeasRepUeNotification”); and D) information of the PLMN (e.g., 5GS 511) with which the MEC App 705 is associated. These parameters and data types may be as defined in ETSI Group Specification (“GS”) MEC 012.

At Step 3, the VRU-ZCF 703 determines a set of network-related zone parameters based on the received data/measurements (see block 717). In various embodiments, the network-related zone parameters indicate: the topological area for the zone (cell IDs, TAs), the QoS requirements within the zone, the network function and exposure requirements within the zone, the value added services required within the zone (e.g., location tracking, V2X message bundling), the transmission modes (unicast, groupcast, broadcast) within the applications within the zone, the interface selection within the zone (Uu, PC5 ), the use of UE relaying or not, and/or whether the zone is dynamic or not.

At Step 4, the VRU-ZCF 703 sends to the MEC App 705 a response indicating the creation and configuration of the VRU zone (see messaging 719). Optionally, the VRU-ZCF 703 also sends the VRU zone configuration.

At Step 5a, the VRU-ZCF 703, if the VRU zone requires the instantiation of a new slice which is tailored to this service in this area, requests the management domain (e.g., the MEO/MEPM 707) to instantiate a new slice and provides the service profile/requirements for such instantiation (see messaging 721). Such instantiation will be done by the OAM (not depicted in FIG. 7) and a positive response will follow with slice parameters for the slice creation (e.g., capabilities, slice coverage, configurations, permissions, etc.). Such exposure from OAM may happen via EGMF/OSS directly, or via BSS.

At Step 5b, the VRU-ZCF 703 sends the configuration parameters for the zone creation to 5GC 511 (e.g., PCF 147 or OAM 130), via the MEO/MEPM 707 (acting here as AF) (see messaging 723). In a further embodiment this parameters can be provided directly to 5GC (if we assume that a locally deployed AF is deployed at MEC host). Such parameters may be one or more of the following:

For communication over Uu, the VRU-ZCF 703 provides information for setting up policies for a future communication within the high-risk zone. Here, the policies and corresponding information may include:
Area of interest (geographical (coordinates, civic/street addresses) or topological, e.g., cell IDs, or DN service area),
Application ID and type,
UE ID (e.g., GPSI) and IP address, group ID, slice ID, DNN (e.g., if the target is a UE that we know and the zone is dynamic),
Time of validity for the zone,
Time duration, expected start/finish times,
Zone ID, Zone type (static, dynamic),
A maximum number of active UEs/VRUs within the zone,
Supported UE types (pedestrian/VRU, V2X UE), and
Service profile/app QoS requirements per UE type

Alternatively (or additionally), the VRU-ZCF 703 may provide pre-configured provisioning policies/parameters for the zone, such as QoS parameters and/or radio parameters, such as those defined in 3GPP TS 23.287.

At Step 5c, the VRU-ZCF 703 sends the configuration parameters for the zone to the RNIS/VIS 701 to allow these functions to provide measurements for the zone (see messaging 725). This message may also include the configuration of reporting (e.g., thresholds for providing notifications/events)

At Step 6a, the MEC App 705 sends to the VRU-ZCF 703 a subscribe request to monitor the VRU zone, and receives an ACK (see messaging 727).

At Step 6b, the VRU-ZCF 703 subscribes to the RNIS/VIS 701 to receive notifications for changes which may affect the VRU zone (see messaging 729). Such notifications include, but are not limited to:
cell change notification (e.g., intra- or inter-zone),
bearer level modifications,
bearer re-configuration for a target VRU, and
Uu/PC5 provisioning change notification within the zone

At Step 7, the VRU-ZCF 703 detects a zone related adaptation based on the monitoring events from RNIS/VIS 701 and/or from the 5GS 511 (see block 731). Such event can be for example a cell change notification outside the zone area.

At Step 8, the VRU-ZCF 701 notifies the MEC App 705 based on the subscription (see messaging 733).

At Step 9, the MEC App 705 may request the adaptation of the VRU zone to the VRU-ZCF 703 based on the notification (see messaging 735).

At Step 10, the VRU-ZCF 703 sends the configuration update to the affected function, such as the RNIS/VIS 701 and/or a network function in the 5GS 511 (e.g., PCF or OAM) (see messaging 737).

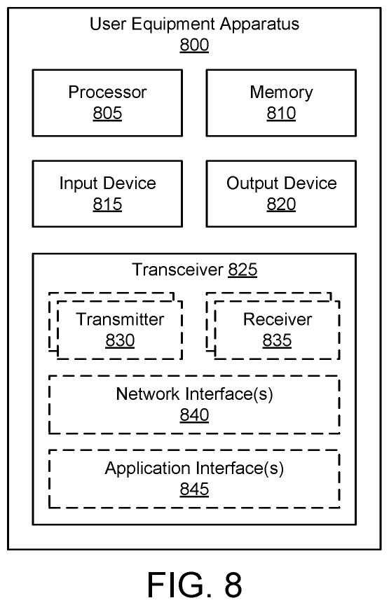

FIG. 8 depicts a user equipment apparatus 800 that may be used for zone configuration and provisioning for VRU protection, according to embodiments of the disclosure. In various embodiments, the user equipment apparatus 800 is used to implement one or more of the solutions described above. Furthermore, the user equipment apparatus 800 may include a processor 805, a memory 810, an input device 815, an output device 820, and a transceiver 825.

In some embodiments, the input device 815 and the output device 820 are combined into a single device, such as a touchscreen. In certain embodiments, the user equipment apparatus 800 may not include any input device 815 and/or output device 820. In various embodiments, the user equipment apparatus 800 may include one or more of: the processor 805, the memory 810, and the transceiver 825, and may not include the input device 815 and/or the output device 820.

As depicted, the transceiver 825 includes at least one transmitter 830 and at least one receiver 835. In some embodiments, the transceiver 825 communicates with one or more cells (or wireless coverage areas) supported by one or more base units 121. In various embodiments, the transceiver 825 is operable on unlicensed spectrum. Moreover, the transceiver 825 may 20) include multiple UE panels supporting one or more beams. Additionally, the transceiver 825 may support at least one network interface 840 and/or application interface 845. The application interface(s) 845 may support one or more APIs. The network interface(s) 840 may support 3GPP reference points, such as Uu, N1, PC5, etc. Other network interfaces 840 may be supported, as understood by one of ordinary skill in the art.

The processor 805, in one embodiment, may include any known controller capable of executing computer-readable instructions and/or capable of performing logical operations. For example, the processor 805 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 805 executes instructions stored in the memory 810 to perform the methods and routines described herein. The processor 805 is communicatively coupled to the memory 810, the input device 815, the output device 820, and the transceiver 825.

In various embodiments, the processor 805 controls the user equipment apparatus 800 to implement the above described UE behaviors. In certain embodiments, the processor 805 may include an application processor (also known as “main processor”) which manages application-domain and operating system (“OS”) functions and a baseband processor (also known as “baseband radio processor”) which manages radio functions.

In various embodiments, the processor 805 detects an emergency event (e.g., collision, highway incident, etc.) and the transceiver 825 transmits an incident notification to a control unit (e.g., VAE server or VASS/VRU-S) in response to the emergency event. The transceiver 825 receives a first set of zone configuration parameters based on a VRU high-risk zone configuration and relays the received zone configuration parameters to one or more nearby V2X UEs.

In some embodiments, the zone configuration parameters include at least one of: A) a topological area for the high-risk zone, B) a network parameter configuration, C) a service provisioning policy, and D) a communication parameter to be applied within the high-risk zone for one or more communication interfaces and communication methods (e.g., for both Uu and side-link interfaces and for different transmission types (unicast, groupcast, broadcast)).

In some embodiments, the transceiver 825 further relays zone information for the high-risk zone to at least one of: A) a VRU UE located in the high-risk zone; B) a vehicular UE located in the high-risk zone; C) a vehicular UE approaching the high-risk zone; and D) a road side unit (“RSU”) within the high risk zone.

The memory 810, in one embodiment, is a computer readable storage medium. In some embodiments, the memory 810 includes volatile computer storage media. For example, the memory 810 may include a RAM, including dynamic RAM (“DRAM”), synchronous dynamic RAM (“SDRAM”), and/or static RAM (“SRAM”). In some embodiments, the memory 810 includes non-volatile computer storage media. For example, the memory 810 may include a hard disk drive, a flash memory, or any other suitable non-volatile computer storage device. In some embodiments, the memory 810 includes both volatile and non-volatile computer storage media.

In some embodiments, the memory 810 stores data related to mobile operation and/or zone configuration and provisioning for VRU protection. For example, the memory 810 may store various parameters, panel/beam configurations, resource assignments, policies, and the like as described above. In certain embodiments, the memory 810 also stores program code and related data, such as an operating system or other controller algorithms operating on the apparatus 800.

The input device 815, in one embodiment, may include any known computer input device including a touch panel, a button, a keyboard, a stylus, a microphone, or the like. In some embodiments, the input device 815 may be integrated with the output device 820, for example, as a touchscreen or similar touch-sensitive display. In some embodiments, the input device 815 includes a touchscreen such that text may be input using a virtual keyboard displayed on the touchscreen and/or by handwriting on the touchscreen. In some embodiments, the input device 815 includes two or more different devices, such as a keyboard and a touch panel.

The output device 820, in one embodiment, is designed to output visual, audible, and/or haptic signals. In some embodiments, the output device 820 includes an electronically controllable display or display device capable of outputting visual data to a user. For example, the output device 820 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 820 may include a wearable display separate from, but communicatively coupled to, the rest of the user equipment apparatus 800, such as a smart watch, smart glasses, a heads-up display, or the like. Further, the output device 820 may be a component of a smart phone, a personal digital assistant, a television, a table computer, a notebook (laptop) computer, a personal computer, a vehicle dashboard, or the like.

In certain embodiments, the output device 820 includes one or more speakers for producing sound. For example, the output device 820 may produce an audible alert or notification (e.g., a beep or chime). In some embodiments, the output device 820 includes one or more haptic devices for producing vibrations, motion, or other haptic feedback. In some embodiments, all or portions of the output device 820 may be integrated with the input device 815. For example, the input device 815 and output device 820 may form a touchscreen or similar touch-sensitive display. In other embodiments, the output device 820 may be located near the input device 815.

The transceiver 825 communicates with one or more network functions of a mobile communication network via one or more access networks. The transceiver 825 operates under the control of the processor 805 to transmit messages, data, and other signals and also to receive messages, data, and other signals. For example, the processor 805 may selectively activate the transceiver 825 (or portions thereof) at particular times in order to send and receive messages.

The transceiver 825 includes at least transmitter 830 and at least one receiver 835. One or more transmitters 830 may be used to provide UL communication signals to a base unit 121, such as the UL transmissions described herein. Similarly, one or more receivers 835 may be used to receive DL communication signals from the base unit 121, as described herein. Although only one transmitter 830 and one receiver 835 are illustrated, the user equipment apparatus 800 may have any suitable number of transmitters 830 and receivers 835. Further, the transmitter(s) 830 and the receiver(s) 835 may be any suitable type of transmitters and receivers. In one embodiment, the transceiver 825 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 825, transmitters 830, and receivers 835 may be implemented as physically separate components that access a shared hardware resource and/or software resource, such as for example, the network interface 840.

In various embodiments, one or more transmitters 830 and/or one or more receivers 835 may be implemented and/or integrated into a single hardware component, such as a multi-transceiver chip, a system-on-a-chip, an Application-Specific Integrated Circuit (“ASIC”), or other type of hardware component. In certain embodiments, one or more transmitters 830 and/or one or more receivers 835 may be implemented and/or integrated into a multi-chip module. In some embodiments, other components such as the network interface 840 or other hardware components/circuits may be integrated with any number of transmitters 830 and/or receivers 835 into a single chip. In such embodiment, the transmitters 830 and receivers 835 may be logically configured as a transceiver 825 that uses one more common control signals or as modular transmitters 830 and receivers 835 implemented in the same hardware chip or in a multi-chip module.

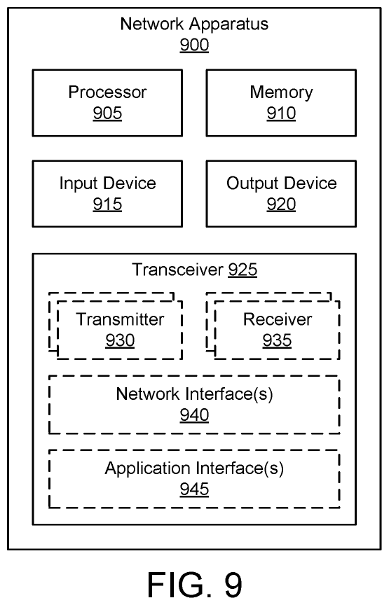

FIG. 9 depicts a network apparatus 900 that may be used for zone configuration and provisioning for VRU protection, according to embodiments of the disclosure. In one embodiment, network apparatus 900 may be one implementation of control unit, such as the VAE server 163, the VASS 167, the Edge Enabler server 173, the V2X server 201, the Enabler Server/VRU Zone Configurator 205, the VAE-S 513, the VASS/VRU server 515, and/or the VRU-ZCF 30 703, as described above. Furthermore, the base network apparatus 900 may include a processor 905, a memory 910, an input device 915, an output device 920, and a transceiver 925.

In some embodiments, the input device 915 and the output device 920 are combined into a single device, such as a touchscreen. In certain embodiments, the network apparatus 900 may not include any input device 915 and/or output device 920. In various embodiments, the network apparatus 900 may include one or more of: the processor 905, the memory 910, and the transceiver 925, and may not include the input device 915 and/or the output device 920.

As depicted, the transceiver 925 includes at least one transmitter 930 and at least one receiver 935. Here, the transceiver 925 may communicates with one or more remote units 105 and/or N5CW devices 110. Additionally, the transceiver 925 may support at least one network interface 940 and/or application interface 945. The application interface(s) 945 may support one or more APIs. The network interface(s) 940 may support 3GPP reference points, such as Uu, N1, N2 and N3. Other network interfaces 940 may be supported, as understood by one of ordinary skill in the art.

The processor 905, in one embodiment, may include any known controller capable of executing computer-readable instructions and/or capable of performing logical operations. For example, the processor 905 may be a microcontroller, a microprocessor, a CPU, a GPU, an auxiliary processing unit, a FPGA, or similar programmable controller. In some embodiments, the processor 905 executes instructions stored in the memory 910 to perform the methods and routines described herein. The processor 905 is communicatively coupled to the memory 910, the input device 915, the output device 920, and the transceiver 925.

In various embodiments, the network apparatus 900 is a RAN node (e.g., gNB) that communicates with one or more UEs, as described herein. In such embodiments, the processor 905 controls the network apparatus 900 to perform the above described RAN behaviors. When operating as a RAN node, the processor 905 may include an application processor (also known as “main processor”) which manages application-domain and operating system (“OS”) functions and a baseband processor (also known as “baseband radio processor”) which manages radio functions.

In various embodiments, the processor 905 controls the apparatus 900 to implement the above VAE-S, VRU-S, VRU-ZCF, and/or VASS functions. In some embodiments, the transceiver 925 receives (e.g., via a network interface 940) a request to create a high-risk zone. Here, the request includes an application requirement that indicates at least a target area. In one embodiment, the target area is a geographical area. In another embodiment, the target area is a service area or another type of area. The processor 905 determines a VRU high-risk zone configuration in response to receiving the application requirement.

The transceiver 925 sends (e.g., via a network interface 940 and/or an air interface) a first set of zone configuration parameters (e.g., a combination of parameters received in Step 1 of FIG. 5A, and parameters derived in Step 2 of FIG. 5A) to at least one UE (e.g., the UE VAE/V2X client) based on the determined VRU high-risk zone configuration. In certain embodiments, the at least one V2X UE includes a vehicular UE. In certain embodiments, the at least one V2X UE includes a VRU UE.

Additionally, the transceiver 925 sends (e.g., via a network interface 940) a second set of zone configuration parameters to at least one network function in a mobile communication network. In one embodiment, the first set of zone configuration parameters is the same as the second set of zone configuration parameters. In certain embodiments, the first set of zone configuration parameters may include at least one parameter not found in the second set of zone parameters. In other embodiments, the second set of zone configuration parameters may include at least one parameter not found in the first set of zone parameters.

In some embodiments, the application requirement indicates a request to map the target area and zone requirements into a topological area and corresponding zone attributes. In some embodiments, the application requirement includes a VRU zone application layer configuration. In such embodiments, the processor 905 may map/translate one or more parameters in the application layer configuration into corresponding zone attributes according to the VRU high-risk zone configuration.

In various embodiments, the VRU high-risk zone configuration includes one or more of: A) a topological area for the high-risk zone, B) a network parameter configuration, C) a service provisioning policy, and D) a communication parameter to be applied within the high-risk zone for one or more communication interfaces and communication methods (e.g., for both Uu and side-link interfaces and for different transmission types (unicast, groupcast, broadcast)).

In some embodiments, the processor 905 detects a target UE that is expected to enter the high-risk zone and controls the transceiver 925 to send an early notification for the expected entry to the high-risk zone to the target UE. In certain embodiments, the transceiver 925 transmits a first set of zone configuration parameters to the target UE entering the high-risk zone.

In some embodiments, the processor 905 creates a dynamic high-risk zone in response to receiving (e.g., via the transceiver 925) an incident notification from a target UE. In one embodiment, the transceiver 925 transmits a request to a vehicular UE to relay zone information for the dynamic high-risk zone to one or more nearby V2X UEs. In another embodiment, the transceiver 925 transmits a request to the mobile communication network to broadcast zone information for the dynamic high-risk zone to one or more nearby V2X UEs. In other embodiments, the transceiver 925 broadcasts zone information for the dynamic high-risk zone to one or more nearby V2X UEs. According to the above embodiments, the one or more nearby V2X UEs may include any of: A) a VRU UE located in the high-risk zone; B) a vehicular UE located in the high-risk zone; C) a vehicular UE approaching the high-risk zone; and D) a road side unit (“RSU”) within the high risk zone. Here, an RSU is serving the area of the high-risk zone and needs to be notified. In one embodiment, the RSU is a UE. In another embodiment, the RSU is an access point.

In some embodiments, an RSU is used as an entity supporting V2P Service that can transmit to, and receive from a UE using V2P application. RSU is implemented in an access point/base station or a stationary UE. In some embodiments, RSU can be mounted in a dedicated cabinet or integrated with a road side controller equipment (e.g., roadworks warning trailer, traffic light).

In some embodiments, the processor 905 configures a broadcast message for communicating zone status information to devices within the high-risk zone area, and wherein the transceiver 925 transmits the broadcast message when a UE crosses a border of the high-risk zone (e.g., enters and/or leaves the VRU zone).

The memory 910, in one embodiment, is a computer readable storage medium. In some embodiments, the memory 910 includes volatile computer storage media. For example, the memory 910 may include a RAM, including dynamic RAM (“DRAM”), synchronous dynamic RAM (“SDRAM”), and/or static RAM (“SRAM”). In some embodiments, the memory 910 includes non-volatile computer storage media. For example, the memory 910 may include a hard disk drive, a flash memory, or any other suitable non-volatile computer storage device. In some embodiments, the memory 910 includes both volatile and non-volatile computer storage media.

In some embodiments, the memory 910 stores data related to mobile operation and/or zone configuration and provisioning for VRU protection. For example, the memory 910 may store parameters, configurations, resource assignments, policies, and the like, as described above. In certain embodiments, the memory 910 also stores program code and related data, such as an operating system or other controller algorithms operating on the apparatus 900.

The input device 915, in one embodiment, may include any known computer input device including a touch panel, a button, a keyboard, a stylus, a microphone, or the like. In some embodiments, the input device 915 may be integrated with the output device 920, for example, as a touchscreen or similar touch-sensitive display. In some embodiments, the input device 915 includes a touchscreen such that text may be input using a virtual keyboard displayed on the touchscreen and/or by handwriting on the touchscreen. In some embodiments, the input device 915 includes two or more different devices, such as a keyboard and a touch panel.

The output device 920, in one embodiment, is designed to output visual, audible, and/or haptic signals. In some embodiments, the output device 920 includes an electronically controllable display or display device capable of outputting visual data to a user. For example, the output device 920 may include, but is not limited to, an LCD display, an LED display, an OLED display, a projector, or similar display device capable of outputting images, text, or the like to a user. As another, non-limiting, example, the output device 920 may include a wearable display separate from, but communicatively coupled to, the rest of the network apparatus 900, such as a smart watch, smart glasses, a heads-up display, or the like. Further, the output device 920 may be a component of a smart phone, a personal digital assistant, a television, a table computer, a notebook (laptop) computer, a personal computer, a vehicle dashboard, or the like.

In certain embodiments, the output device 920 includes one or more speakers for producing sound. For example, the output device 920 may produce an audible alert or notification (e.g., a beep or chime). In some embodiments, the output device 920 includes one or more haptic devices for producing vibrations, motion, or other haptic feedback. In some embodiments, all or portions of the output device 920 may be integrated with the input device 915. For example, the input device 915 and output device 920 may form a touchscreen or similar touch-sensitive display. In other embodiments, the output device 920 may be located near the input device 915.

The transceiver 925 includes at least transmitter 930 and at least one receiver 935. One or more transmitters 930 may be used to communicate with the UE, as described herein. Similarly, one or more receivers 935 may be used to communicate with network functions in the PLMN and/or RAN, as described herein. Although only one transmitter 930 and one receiver 935 are illustrated, the network apparatus 900 may have any suitable number of transmitters 930 and receivers 935. Further, the transmitter(s) 930 and the receiver(s) 935 may be any suitable type of transmitters and receivers.

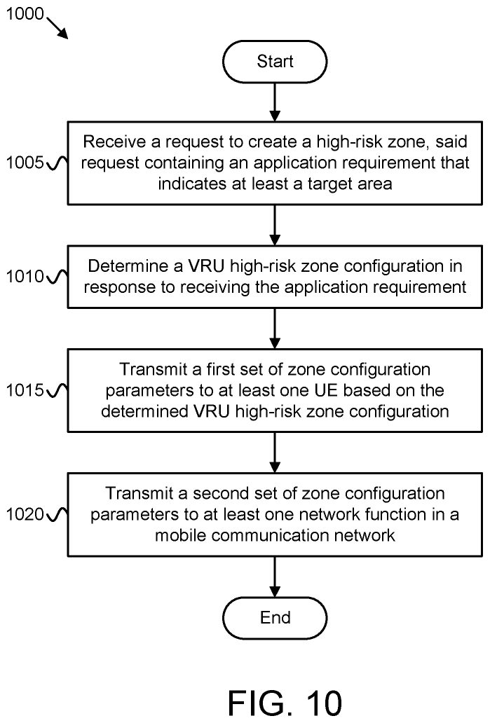

FIG. 10 depicts one embodiment of a method 1000 for zone configuration and provisioning for VRU protection, according to embodiments of the disclosure. In various embodiments, the method 1000 is performed by a control unit, such as the VAE server 163, the VASS 167, the Edge Enabler server 173, the V2X server 201, the Enabler Server/VRU Zone Configurator 205, VAE-S 513, VASS/VRU server 515, VRU-ZCF 703, and/or the network apparatus 900, as described above. In some embodiments, the method 1000 is performed by a processor, such as a microcontroller, a microprocessor, a CPU, a GPU, an auxiliary processing unit, a FPGA, or the like.

The method 1000 begins and receives 1005 a request to create a high-risk zone, said request containing an application requirement that indicates at least a target area. The method 1000 includes determining 1010 a VRU high-risk zone configuration in response to receiving the application requirement. The method 1000 includes transmitting 1015 a first set of zone configuration parameters to at least one UE based on the determined VRU high-risk zone configuration. The method 1000 includes transmitting 1020 a second set of zone configuration parameters to at least one network function in a mobile communication network. The method 1000 ends.

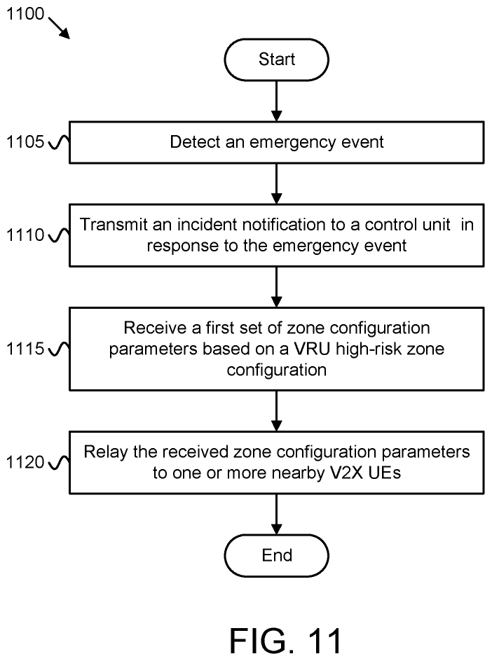

FIG. 11 depicts one embodiment of a method 1100 for zone configuration and provisioning for VRU protection, according to embodiments of the disclosure. In various embodiments, the method 1100 is performed by a V2X communication device in a mobile communication network, such as the VRU device 101, the remote unit 105, the vehicle 161, the V2X UE 401, the V2X UE 501, the target UE 503, the alerting UE 601, and/or the user equipment apparatus 800, as described above. In some embodiments, the method 1100 is performed by a processor, such as a microcontroller, a microprocessor, a CPU, a GPU, an auxiliary processing unit, a FPGA, or the like.

The method 1100 begins and detects 1105 an emergency event (e.g., collision, highway incident, etc.). The method 1100 includes transmitting 1110 an incident notification to a control unit (e.g., a VAE server or VASS/VRU-S) in response to the emergency event. The method 1100 includes receiving 1115 a first set of zone configuration parameters based on a VRU high-risk zone configuration. The method 1100 includes relaying 1120 the received zone configuration parameters to one or more nearby V2X UEs. The method 1100 ends.

Disclosed herein is a first apparatus for zone configuration and provisioning for VRU protection, according to embodiments of the disclosure. The first apparatus may be implemented by a control unit, such as the VAE server 163, the VASS 167, the Edge Enabler server 173, the V2X server 201, the Enabler Server/VRU Zone Configurator 205, VAE-S 513, VASS/VRU server 515, VRU-ZCF 703, and/or the network apparatus 900, described above. The first apparatus includes a receiver (e.g., of a network interface) that receives a request to create a high-risk zone, said request including an application requirement that indicates at least a target area and a processor that determines a VRU high-risk zone configuration in response to receiving the application requirement. The first apparatus includes a transmitter (e.g., of the network interface) that transmits a first set of zone configuration parameters to at least one UE (e.g., VAE/V2X client) based on the determined VRU high-risk zone configuration and transmits a second set of zone configuration parameters to at least one network function in a mobile communication network.

In some embodiments, the application requirement indicates a request to map the target area and zone requirements into a topological area and corresponding zone attributes. In some embodiments, the application requirement includes a VRU zone application layer configuration. In various embodiments, the VRU high-risk zone configuration includes one or more of: A) a topological area for the high-risk zone, B) a network parameter configuration, C) a service provisioning policy, and D) a communication parameter to be applied within the high-risk zone for one or more communication interfaces and communication methods (e.g., for both Uu and side-link interfaces and for different transmission types (unicast, groupcast, broadcast)).

In some embodiments, the processor detects a target UE that is expected to enter the high-risk zone, and wherein the transmitter transmits an early notification for the expected entry to the high-risk zone to the target UE, based on the detection. In certain embodiments, the transmitter transmits a first set of zone configuration parameters to the target UE entering the high-risk zone.

In some embodiments, the processor creates a dynamic high-risk zone in response to the receiver receiving an incident notification from a target UE. In one embodiment, the transmitter transmits a request to a vehicular UE to relay zone information for the dynamic high-risk zone to one or more nearby V2X UEs. In another embodiment, the transmitter transmits a request to the mobile communication network to broadcast zone information for the dynamic high-risk zone to one or more nearby V2X UEs. In other embodiments, the transmitter broadcasts zone information for the dynamic high-risk zone to one or more nearby V2X UEs. According to the above embodiments, the one or more nearby V2X UEs may include any of: A) a VRU UE located in the high-risk zone; B) a vehicular UE located in the high-risk zone; C) a vehicular UE approaching the high-risk zone; and D) a road side unit within the high risk zone.

In some embodiments, the processor configures a broadcast message for communicating zone status information to devices within the high-risk zone area, and wherein the transmitter transmits the broadcast message when a UE crosses a border of the high-risk zone (e.g., enters and/or leaves the VRU zone).

In some embodiments, the processor queries an information service function (e.g., RNIS/VIS) for data about a target edge area associated with the high-risk zone and determines network-related zone parameters based on data received for the target edge area. In such embodiments, the second set of zone configuration parameters includes the at least one of the network-related zone parameters.

Disclosed herein is a first method for zone configuration and provisioning for VRU protection, according to embodiments of the disclosure. The first method may be performed by a control unit, such as the VAE server 163, the VASS 167, the Edge Enabler server 173, the V2X server 201, the Enabler Server/VRU Zone Configurator 205, VAE-S 513, VASS/VRU server 515, VRU-ZCF 703, and/or the network apparatus 900, described above. The first method includes receiving a request to create a high-risk zone, said request including an application requirement that indicates at least a target area, and determining a VRU high-risk zone configuration in response to receiving the application requirement. The first method includes transmitting a first set of zone configuration parameters to at least one UE (e.g., VAE/V2X client) based on the determined VRU high-risk zone configuration and transmitting a second set of zone configuration parameters to at least one network function in a mobile communication network.

In some embodiments, the application requirement indicates a request to map the target area and zone requirements into a topological area and corresponding zone attributes. In some embodiments, the application requirement includes a VRU zone application layer configuration. In various embodiments, the VRU high-risk zone configuration includes one or more of: A) a topological area for the high-risk zone, B) a network parameter configuration, C) a service provisioning policy, and D) a communication parameter to be applied within the high-risk zone for one or more communication interfaces and communication methods (e.g., for both Uu and side-link interfaces and for different transmission types (unicast, groupcast, broadcast)).

In some embodiments, the first method includes detecting a target UE that is expected to enter the high-risk zone and transmitting an early notification for the expected entry to the high-risk zone to the target UE, based on the detection. In certain embodiments, the first method further includes transmitting a first set of zone configuration parameters to the target UE entering the high-risk zone.

In some embodiments, the first method includes receiving an incident notification from a target UE and creating a dynamic high-risk zone in response to the incident notification. In one embodiment, the first method further includes requesting a vehicular UE to relay zone information to one or more nearby V2X UEs. In another embodiment, the first method further includes requesting the mobile communication network to broadcast the zone information for the dynamic high-risk zone to one or more nearby V2X UEs.

In other embodiments, the first method further includes broadcasting the zone information for the dynamic high-risk zone to one or more nearby V2X UEs. According to the above embodiments, the one or more nearby V2X UEs may include any of: A) a VRU UE located in the high-risk zone; B) a vehicular UE located in the high-risk zone; C) a vehicular UE approaching the high-risk zone; and D) a road side unit within the high risk zone.

In some embodiments, the first method includes configuring a broadcast message for communicating zone status information to devices within the high-risk zone area and transmitting the broadcast message when a UE crosses a border of the high-risk zone (e.g., enters and/or leaves the VRU zone).

In some embodiments, the first method includes querying an information service function (e.g., RNIS/VIS) for data about a target edge area associated with the high-risk zone, receiving data for the target edge area, and determining network-related zone parameters based on the received data. In such embodiments, the second set of zone configuration parameters includes the at least one of the network-related zone parameters.

Disclosed herein is a second apparatus for zone configuration and provisioning for VRU protection, according to embodiments of the disclosure. The second apparatus may be implemented by a V2X communication device in a mobile communication network, such as the VRU device 101, the remote unit 105, the vehicle 161, the V2X UE 401, the V2X UE 501, the target UE 503, the alerting UE 601, and/or the user equipment apparatus 800, described above. The second apparatus includes a processor that detects an emergency event (e.g., collision, highway incident, etc.) and a transceiver that transmits an incident notification to a control unit (e.g., VAE server or VASS/VRU-S) in response to the emergency event. The transceiver receives a first set of zone configuration parameters based on a VRU high-risk zone configuration and relays the received zone configuration parameters to one or more nearby V2X UEs.

In some embodiments, the zone configuration parameters include at least one of: A) a topological area for the high-risk zone, B) a network parameter configuration, C) a service provisioning policy, and D) a communication parameter to be applied within the high-risk zone for one or more communication interfaces and communication methods (e.g., for both Uu and side-link interfaces and for different transmission types (unicast, groupcast, broadcast)).

In some embodiments, the transceiver further relays zone information for the high-risk zone to at least one of: A) a VRU UE located in the high-risk zone; B) a vehicular UE located in the high-risk zone; C) a vehicular UE approaching the high-risk zone; and D) a road side unit (“RSU”) within the high risk zone.

Disclosed herein is a second method for zone configuration and provisioning for VRU protection, according to embodiments of the disclosure. The second method may be performed by a V2X communication device in a mobile communication network, such as the VRU device 101, the remote unit 105, the vehicle 161, the V2X UE 401, the V2X UE 501, the target UE 503, the alerting UE 601, and/or the user equipment apparatus 800, described above. The second method includes detecting an emergency event (e.g., collision, highway incident, etc.) and transmitting an incident notification to a control unit (e.g., VAE server or VASS/VRU-S) in response to the emergency event. The second method includes receiving a first set of zone configuration parameters based on a VRU high-risk zone configuration and relaying the received zone configuration parameters to one or more nearby V2X UEs.

In some embodiments, the zone configuration parameters include at least one of: A) a topological area for the high-risk zone, B) a network parameter configuration, C) a service provisioning policy, and D) a communication parameter to be applied within the high-risk zone for one or more communication interfaces and communication methods (e.g., for both Uu and side-link interfaces and for different transmission types (unicast, groupcast, broadcast)).

In some embodiments, the second method further including relaying zone information for the high-risk zone to at least one of: A) a VRU UE located in the high-risk zone B) a vehicular UE located in the high-risk zone; C) a vehicular UE approaching the high-risk zone; and D) a road side unit (“RSU”) within the high risk zone.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A control unit apparatus comprising:
a receiver that receives a request to create a high-risk zone, said request comprising an application requirement that indicates at least a target area;
a processor that determines a Vulnerable Road User (“VRU”) high-risk zone configuration in response to receiving the application requirement; and
a transmitter that:
transmits a first set of zone configuration parameters to at least one User Equipment (“UE”) based on the determined VRU high-risk zone configuration; and
transmits a second set of zone configuration parameters to at least one network function in a mobile communication network.

2. The apparatus of claim 1, wherein the application requirement indicates a request to map the target area and zone requirements into a topological area and corresponding zone attributes.

3. The apparatus of claim 1 or 2, wherein the application requirement comprises a VRU zone application layer configuration, wherein the VRU high-risk zone configuration comprises at least one of:
a topological area for the high-risk zone,
a network parameter configuration,
a service provisioning policy, and
a communication parameter to be applied within the high-risk zone for one or more communication interfaces and communication methods.

4. The apparatus of claim 1, 2 or 3, wherein the processor detects a target UE that is expected to enter the high-risk zone, and wherein the transmitter transmits an early notification for the expected entry to the high-risk zone to the target UE, based on the detection.

5. The apparatus of claim 4, wherein the transmitter transmits a first set of zone configuration parameters to the target UE entering the high-risk zone.

6. The apparatus of any preceding claim, wherein the processor creates a dynamic high-risk zone in response to the receiver receiving an incident notification from a target UE.

7. The apparatus of claim 6, wherein the transmitter broadcasts zone information for the dynamic high-risk zone to at least one of:
a VRU UE located in the high-risk zone;
a vehicular UE located in the high-risk zone;
a vehicular UE approaching the high-risk zone; and
a road side unit within the high-risk zone.

8. The apparatus of claim 6, wherein the transmitter transmits a request to the mobile communication network to broadcast zone information for the dynamic high-risk zone to at least one of:
a VRU UE located in the high-risk zone;
a vehicular UE located in the high-risk zone;
a vehicular UE approaching the high-risk zone; and
a road side unit within the high-risk zone.

9. The apparatus of claim 6, wherein the transmitter transmits a request to a vehicular UE to relay zone information for the dynamic high-risk zone to one or more nearby vehicular UEs.

10. The apparatus of any preceding claim, wherein the processor configures a broadcast message for communicating zone status information to devices within the high-risk zone area, and wherein the transmitter transmits the broadcast message when a UE crosses a border of the high-risk zone (i.e., enters and/or leaves the VRU zone).

11. The apparatus of any preceding claim, wherein the processor further:
queries an information service function for data about a target edge area associated with the high-risk zone;
receives data for the target edge area; and
determines network-related zone parameters based on the received data,
wherein the second set of zone configuration parameters comprises the at least one of the network-related zone parameters.

12. A method of a control unit, the method comprising:
receiving a request to create a high-risk zone, said request comprising an application requirement that indicates at least a target area;
determining a Vulnerable Road User (“VRU”) high-risk zone configuration, in response to receiving the application requirement;
transmitting a first set of zone configuration parameters to at least one User Equipment (“UE”) based on the determined VRU high-risk zone configuration; and
transmitting a second set of zone configuration parameters to at least one network function in a mobile communication network.

13. A User Equipment (“UE”) apparatus comprising:
a processor that detects an emergency event; and
a transceiver that:
transmits an incident notification to a control unit in response to the emergency event;
receives a first set of zone configuration parameters based on a VRU high-risk zone configuration; and
relays the received zone configuration parameters to one or more nearby V2X UEs.

14. The apparatus of claim 13, wherein the zone configuration parameters comprise at least one of:
a topological area for the high-risk zone,
a network parameter configuration,
a service provisioning policy, and
a communication parameter to be applied within the high-risk zone for one or more communication interfaces and communication methods.

15. The apparatus of claim 13 or 14, wherein the transceiver further relays zone information for the high-risk zone to at least one of:
a VRU UE located in the high-risk zone;
a vehicular UE located in the high-risk zone;
a vehicular UE approaching the high-risk zone; and
a road side unit (“RSU”) within the high-risk zone.
